(19) United States
(12) Patent Application Publication
(10) Pub. No.: US 2025/0349854 A1
(43) Pub. Date: Nov. 13, 2025

(54) ELECTROCHEMICAL CELL ELECTRODE WITH ENHANCED ADHESION PROPERTIES

(71) Applicant: Lyten, Inc., San Jose, CA (US)

(72) Inventors: Valeria Perez, San Jose, CA (US); Arjun Mendiratta, La Honda, CA (US); Che-Yu Wu, Fremont, CA (US)

(21) Appl. No.: 18/658,830

(22) Filed: May 8, 2024

(51) Int. Cl. H01M 4/62; H01M 4/02; H01M 4/133; H01M 4/136; H01M 4/58; H01M 4/587

(52) U.S. Cl. CPC H01M 4/622; H01M 4/133; H01M 4/136; H01M 4/5815; H01M 4/587; H01M 2004/021; H01M 2004/028

(57) ABSTRACT

The present disclosure relates to an electrochemical cell electrode with enhanced adhesion properties. In principle, the disclosed electrode includes an active material and a binder slurry. The binder slurry comprises a polymer and a microfiber, and the polymer constitutes at least 0.25% weight of the combined active material and binder slurry, while the microfiber constitutes at least 1% weight. The microfiber may contribute to increasing the adhesion, cohesion, structural integrity, and durability of the electrode. The strands of fibrous network may be used to create a 3D structure within the electrode, resulting in enhanced adhesion and other properties.

### FIELD OF THE INVENTION

The present disclosure generally relates to the field of electrochemical cells, and more specifically, to the use of a binder slurry comprising a polymer and a water-dispersible microfiber in the electrodes of such cells.

### BACKGROUND

Electrochemical cells, such as batteries, are ubiquitous in modern life, powering everything from portable electronics to electric vehicles. These cells typically comprise two electrodes, an anode and a cathode, and an electrolyte. The electrodes are often made from active materials that can undergo redox reactions to store and release electrical energy. One common type of active material used in electrodes is lithium-sulfur compounds. These compounds have high theoretical energy densities, making them attractive for use in high-capacity batteries. However, the practical implementation of lithium-sulfur compounds in electrodes can be challenging due to issues such as poor electrical conductivity and rapid capacity fading.

Currently, to address these issues, binders, as one example, are often used in the fabrication of electrodes. Binders help to hold the active material particles together and adhere them to a current collector. They play a pivotal role in maintaining the structural integrity of the electrode and ensuring good electrical contact between the active material particles and the current collector. However, the selection of a binder often comes with a give-and-take relationship of flexibility, adhesion properties, and chemical stability.

As such, the choice of binder and its formulation can have a substantial impact on the performance of the electrode and the overall cell. Therefore, the development of effective binder formulations remains an area of ongoing research and development in the field of electrochemical cells.

As such, there is thus a need for addressing these and/or other issues associated with the prior art.

### SUMMARY

In some aspects, the techniques described herein relate to an electrode of an electrochemical cell, including: a cathode, an active material; and a binder slurry including a polymer and microfiber, wherein the polymer is at least 0.25% weight of a combination of the active material and the binder slurry, and the microfiber is at least 1% weight of the combination.

In some aspects, the techniques described herein relate to an electrode, wherein the binder slurry is aqueous.

In some aspects, the techniques described herein relate to an electrode, wherein the microfiber is water-dispersible.

In some aspects, the techniques described herein relate to an electrode, wherein the microfiber is nanofibrillated cellulose.

In some aspects, the techniques described herein relate to an electrode, wherein the microfiber is microfibrillated cellulose (MFC).

In some aspects, the techniques described herein relate to an electrode, wherein the MFC is configured to have a diameter between 10-100 nm.

In some aspects, the techniques described herein relate to an electrode, wherein the MFC is configured to have a length of at least 10 microns.

In some aspects, the techniques described herein relate to an electrode, wherein the polymer includes partially lithiated polyacrylic acid (LiPAA).

In some aspects, the techniques described herein relate to an electrode, wherein the active material is configured to have a surface area of at least 100 m²/g.

In some aspects, the techniques described herein relate to an electrode, wherein the active material is a lithium-sulfur compound.

In some aspects, the techniques described herein relate to an electrode, wherein the binder slurry is configured to form a 3D structure.

In some aspects, the techniques described herein relate to an electrode, wherein the 3D structure is formed based on entangling of the microfiber.

In some aspects, the techniques described herein relate to an electrode, wherein the microfiber is bonded to the active material.

In some aspects, the techniques described herein relate to an electrode, wherein the microfiber is bonded between a first fiber of the microfiber and a second fiber of the microfiber.

In some aspects, the techniques described herein relate to an electrode, wherein the electrode is configured such that an adhesion of the electrode is greater compared to an electrode configured without the microfiber.

In some aspects, the techniques described herein relate to an electrode, wherein the electrode is configured such that cycling of the electrode is increased compared to an electrode configured without the microfiber.

In some aspects, the techniques described herein relate to an electrode, wherein the electrode is configured such that a cohesion of the electrode is greater compared to an electrode configured without the microfiber.

In some aspects, the techniques described herein relate to an electrode, wherein the electrode is configured such that the active material is secured by the microfiber, and the securing increases the cohesion of the electrode.

In some aspects, the techniques described herein relate to an electrode, wherein the electrode is configured such that the microfiber increases a structural integrity of the electrode.

In some aspects, the techniques described herein relate to an electrode, wherein the electrode is configured such that a coating texture of the electrode is based on the polymer.

In some aspects, the techniques described herein relate to an electrode, wherein the active material includes one or more carbonaceous materials.

### BRIEF DESCRIPTION OF THE DRAWINGS

FIG. 1 is a schematic representation of a cathode composition, according to aspects of the present disclosure.

FIG. 2 illustrates multiple views of cathode particles with various binders, according to aspects of the present disclosure.

FIG. 3 shows binder formulation line graphs, according to aspects of the present disclosure.

FIG. 4 shows a binder formulation line graph, according to aspects of the present disclosure.

FIG. 5 presents surface views, according to aspects of the present disclosure.

FIG. 6 depicts results of a fold test, according to aspects of the present disclosure.

FIG. 7 illustrates a graph representing the relationship between binder formulation and adhesion, according to aspects of the present disclosure.

FIG. 8 shows a graph illustrating battery capacity over a number of charge-discharge cycles, according to aspects of the present disclosure.

FIG. 9 depicts a graph illustrating the adhesion properties of different cathode formulations, according to aspects of the present disclosure.

FIG. 10 presents graphs comparing the efficiency of two different cathode compositions in battery cells, according to aspects of the present disclosure.

FIG. 11 depicts micrographs showing different particle morphologies, according to aspects of the present disclosure.

FIG. 12A through FIG. 12Y depict structured carbons, various carbon nanoparticles, various carbon-containing aggregates, and various three-dimensional carbon-containing structures that are grown over other materials, according to some embodiments of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure generally pertains to the field of electrochemical cells, and more specifically, to the use of a binder slurry in the electrodes of such cells. The binder slurry may comprise a polymer and a microfiber (which may be water-dispersible), which together contribute to an overall performance and efficiency of the electrochemical cell.

It is recognized that a variety of binders may be used to improve an electrochemical cell. For example, polymers are a common type of binder used in electrodes due to their flexibility, adhesion properties, and chemical stability. One such polymer that has been used as a binder is partially lithiated polyacrylic acid (LiPAA). LiPAA has been found to provide good adhesion and cohesion properties, making it suitable for use in high-capacity electrodes. In addition to polymers, other types of materials have been explored for use as binders. For instance, microfibers have been investigated due to their potential to form a fibrous network that can hold the active material particles together. These microfibers can be made from various materials, including cellulose, a naturally occurring polymer found in the cell walls of plants. Microofibrillated cellulose (MFC) is a type of cellulose microfiber that has been used in various applications due to its high strength, flexibility, and large surface area. MFC is typically produced by mechanically fibrillating cellulose fibers to create a network of nanoscale fibers. These fibers can be dispersed in water to form a slurry, which can then be used in various applications.

In some aspects, the active material used in the electrode may have a high surface area, which can present challenges in terms of maintaining structural integrity and ensuring good electrical contact between the active material particles and the current collector. The binder slurry, comprising a polymer and a water-dispersible microfiber, may be particularly beneficial in this context. The polymer, which may be at least 0.25% weight of the active material plus the binder slurry, can provide flexibility, adhesion properties, and chemical stability. The water-dispersible microfiber, which may be at least 1% weight of the active material plus the binder slurry, can form a fibrous network that holds the active material particles together.

In some cases, the polymer used in the binder slurry may be partially lithiated polyacrylic acid (LiPAA), while the water-dispersible microfiber may be microofibrillated cellulose (MFC). The MFC may have a diameter between 10-100 nm and a length of at least 10 microns, providing a high strength, flexibility, and large surface area that can enhance the performance of the electrode.

In other aspects, the MFC is high shear mixed, and the high shear mixed-MFC, LiPAA, and active material are mixed together using a centrifugal or planetary mixer. This process can ensure a homogeneous distribution of the polymer and microfiber in the slurry, which can further enhance the adhesion and cohesion properties of the electrode.

The use of a binder slurry comprising a polymer and a microfiber in the electrodes of electrochemical cells can provide several benefits. For instance, it can improve the adhesion and cohesion of the electrode, enhance the electrical contact between the active material particles and the current collector, and increase the overall performance and efficiency of the electrochemical cell.

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments-they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### DESCRIPTIONS OF EXEMPLARY EMBODIMENTS

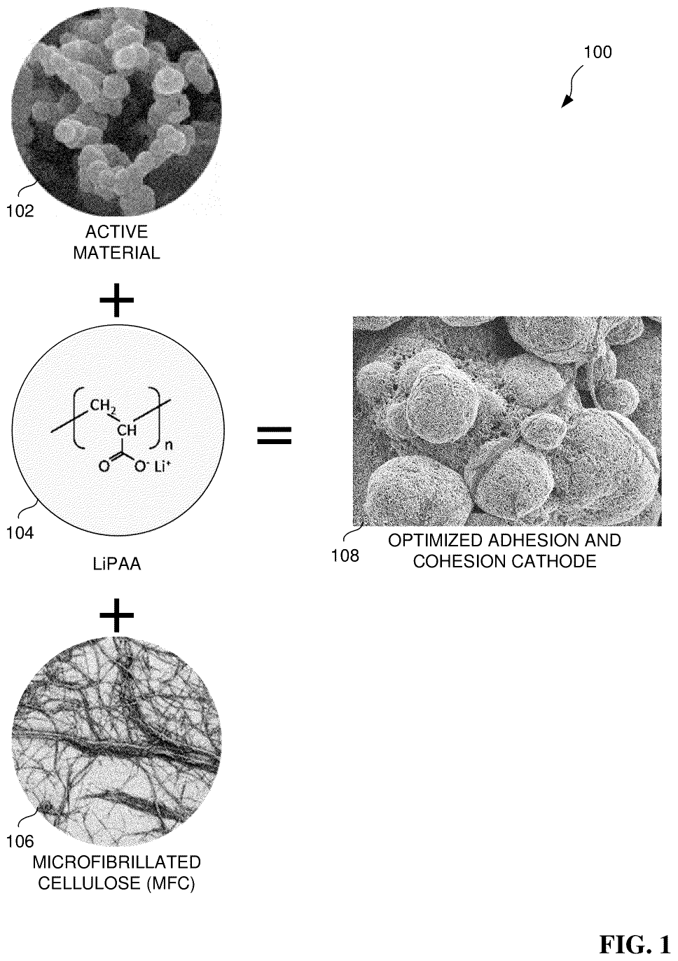

FIG. 1 is a schematic representation 100 of a cathode composition, according to aspects of the present disclosure.

As shown, a cathode composition schematic 100 is depicted. The schematic 100 includes active material particles 102, a lithium polyacrylate (LiPAA) compound 104, and microfibrillated cellulose fibers (MFC) 106. These components are combined to form an optimized cathode structure 108. In various embodiments, the optimized cathode structure 108 with respect to adhesion, cohesion, etc. In some cases, the active material particles 102 may have a surface area of at least 100 m²/g. In other cases, the active material particles 102 may be a lithium-sulfur compound.

The LiPAA compound 104 acts as a binder and dispersant in the electrode. Additionally, the MFC 106 provide a fibrous network that enhances the mechanical integrity of the cathode. In some cases, the cellulose fibers may include microfibrillated cellulose fibers, nanofibrillated cellulose fibers, etc. In other cases, the microfibrillated cellulose fibers 106 may have a diameter between 10-100 nm and a length of at least 10 microns.

Together, these components (active material particles 102, LiPAA compound 104, and MFC 106) may result in an optimized adhesion and cohesion cathode structure 108. Such an optimized configuration is intended to improve the performance and reliability of Li—S batteries.

In one embodiment, the MFC is high shear mixed, and the high shear mixed-MFC, LiPAA, and active material are mixed together using a centrifugal or planetary mixer. This process can ensure a homogeneous distribution of the polymer and microfiber in the slurry, which can further enhance the adhesion and cohesion properties of the electrode.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

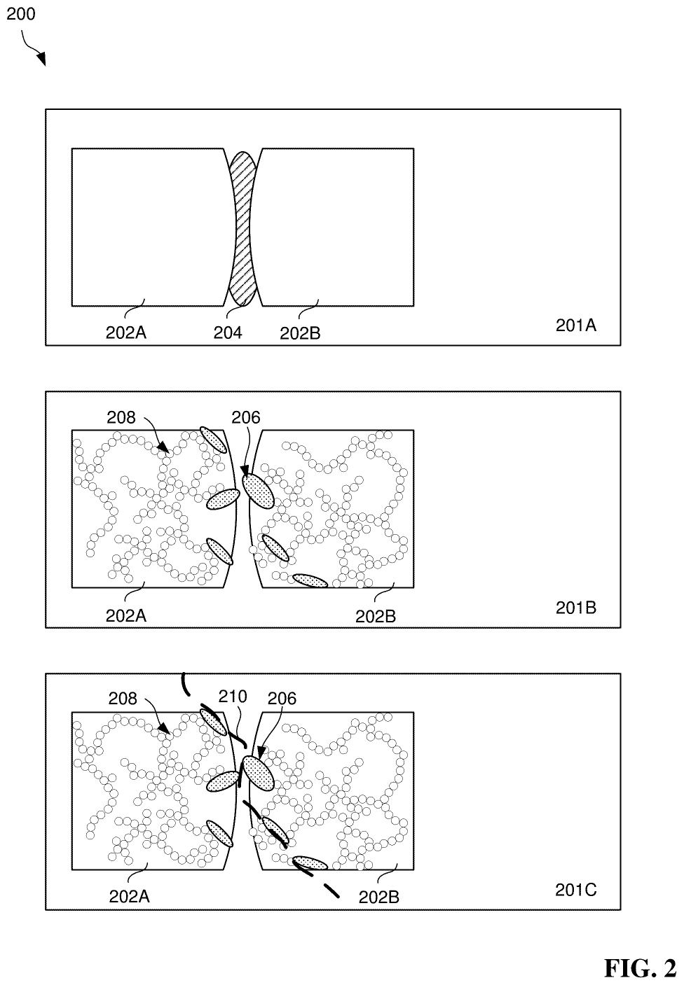

FIG. 2 illustrates multiple views of 200 cathode particles with various binders, according to aspects of the present disclosure. As an option, the multiple views of 200 may be implemented in the context of any one or more of the embodiments set forth in any previous and/or subsequent figure(s) and/or description thereof. Of course, however, the multiple views of 200 may be implemented in the context of any desired environment. Further, the aforementioned definitions may equally apply to the description below.

As shown, top diagram 201A shows a non-porous cathode shown with cathode particles 202A and 202B and a polymer binder 204. Note that top diagram 201A displays a large contact area between the cathode particles 202A and 202B, and the polymer binder 204. The polymer binder 204 may be used to glue (and/or otherwise bind) the cathode particles 202A and 202B to result in good cohesion with limited efficiency of the polymer binder 204.

The middle diagram 201B shows a porous cathode with cathode particles 202A and 202B, polymer binders 206, and porous agglomerates 208. Note that the middle diagram 201B displays a small contact area between the cathode particles 202A and 202B, and the polymer binder 206. Additionally, comparing the middle diagram 201B to the top diagram 201A, there is a smaller contact area for the polymer binder, resulting in less cohesion, but greater efficiency of the polymer binder 206 which can, in a more fluid manner, bind with the porous agglomerates 208.

The bottom diagram 201C shows a porous cathode with cathode particles 202A and 202B, polymer binders 206, porous agglomerates 208, and fiber 210. Note that the bottom diagram 201C shows that the fiber 210 may function as a structure for binding the polymer binders 206 and the porous agglomerates 208. Thus, in comparing, for example, the bottom diagram 201C to the middle diagram 201B and the top diagram 201A, the bottom diagram 201C may achieve both good cohesion (similar to the good cohesion of the top diagram 201A) and good efficiency of the polymer binder (similar to the good mobility of the middle diagram 201B).

The bottom diagram 201C further displays a more efficient use of the polymer binders 206 that can be more securely held to the porous agglomerates 208 via the fiber 210. From this perspective, therefore, the fiber 210 may be used to strengthen the structure of the cathode.

In various embodiments, a slurry of the fiber 210, the polymer binders 206, and the porous agglomerates 208 (i.e. the active material) may be combined to ensure a homogenous distribution of the polymer binders 206 and the fiber 210. In one embodiment, the MFC is high shear mixed, and the high shear mixed-MFC, LiPAA, and active material are mixed together using a centrifugal or planetary mixer. Additionally, a homogenous distribution may enhance the adhesion and cohesion properties of the resulting electrode.

In various embodiments, the inclusion of the microfiber may increase cohesion properties of the resulting electrode. For example, the microfiber may allow the electrode material to retain its structural integrity amidst the rigorous conditions of charge and discharge cycles. Further, microfiber may increase the stability of electrode's constituent particles or components to adhere firmly to one another, resisting fragmentation or disintegration under mechanical stress and electrochemical reactions. As such, microfibers may be used to secure the active material within the electrode, preventing it from detaching or breaking apart during use. Such stability may assist in preserving the electrode's electrochemical properties (including capacity and rate capability), by mitigating structural degradation caused by repeated expansion and contraction.

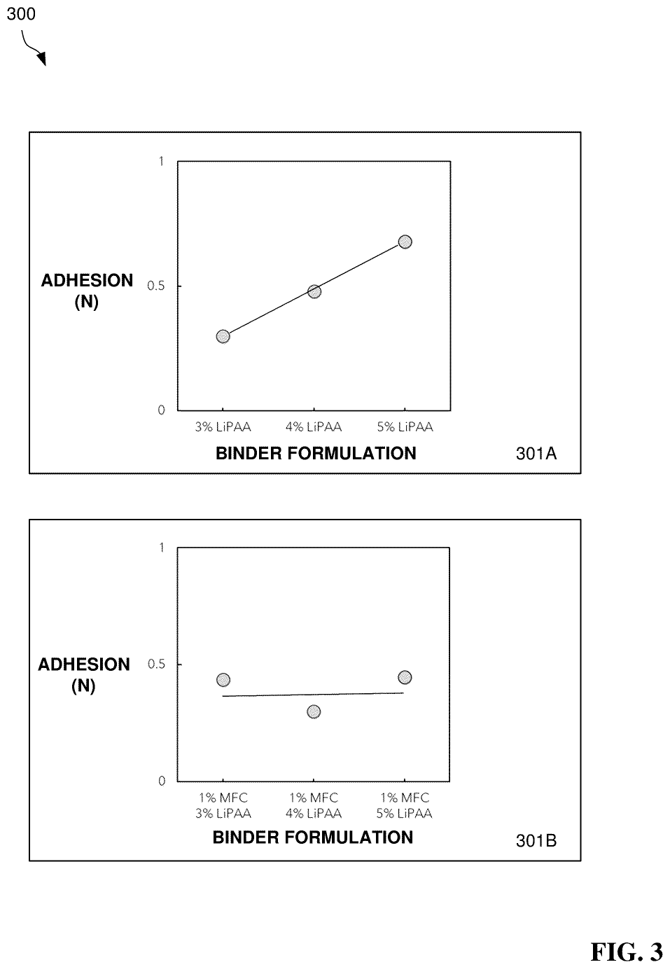

FIG. 3 shows binder formulation line graphs 300, in accordance with one embodiment. As an option, the graphs 300 may be implemented in the context of any one or more of the embodiments set forth in any previous and/or subsequent figure(s) and/or description thereof. Of course, however, the graphs 300 may be implemented in the context of any desired environment. Further, the aforementioned definitions may equally apply to the description below.

As shown, graph 301A illustrates a line chart graph representing the relationship between binder formulation and adhesion. The graph includes data points indicating increasing adhesion with higher percentages of a polymer binder, such as LiPAA. This suggests that the amount of polymer in the binder formulation may influence the adhesion properties of the electrode, namely that as the amount of a polymer binder increases, the adhesion increases as well.

Additionally, graph 301B also illustrates a line chart graph representing the relationship between binder formulation and adhesion. The binder formulation may include both a polymer binder, such as LiPAA, and a fiber, such as MFC. The plot demonstrates that the amount of a polymer binder and fiber may influence the adhesion properties of the electrode. In particular, it is noted that as the amount of fiber remains static and as the amount of polymer binder increases, as shown in the graph 301B, the adhesion properties of the electrode remains relatively the same.

In comparing the graph 301B to the graph 301A, it is noted that the addition of fiber at 3% LiPAA increased the adhesion, at 4% LiPAA the adhesion decreased slightly, and at 5% LiPAA decreased the adhesion. Thus, the addition of a fiber (such as MFC) may, in particular, have an effect on the adhesion with lower percentage weight amounts of a polymer binder. Additionally, the graph 301B emphasizes that increasing LiPAA does not linearly increase adhesion.

It is to be appreciated that percentages, as represented in the present graph 301A and the graph 301B (as well as any other graph within the present disclosure) refers to a percentage of weight of the resulting composition.

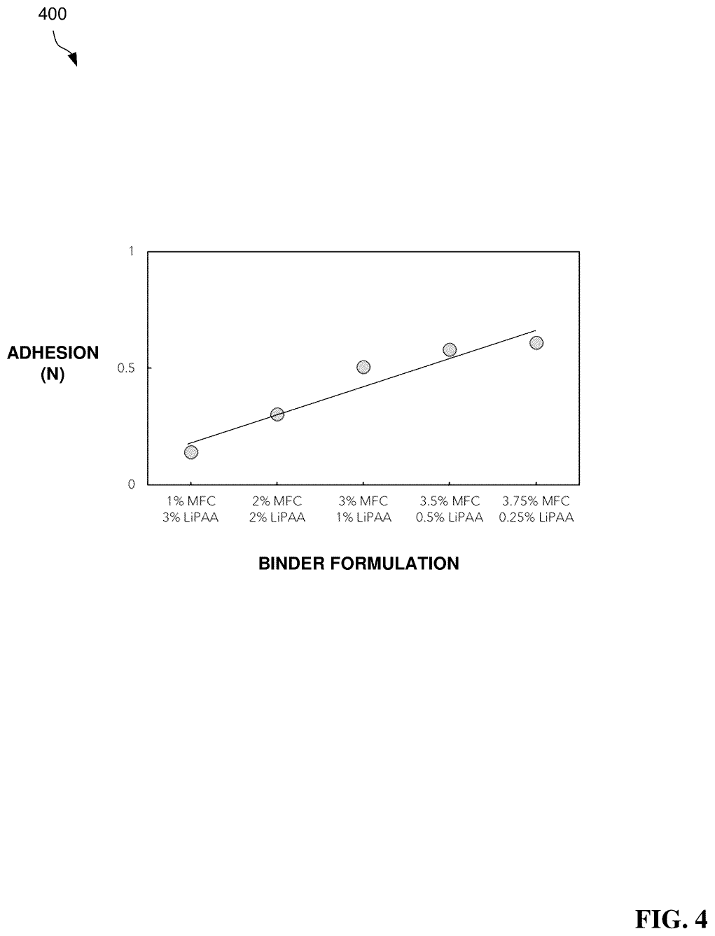

FIG. 4 illustrates a binder formulation line graph 400, in accordance with one embodiment. As an option, the graph 400 may be implemented in the context of any one or more of the embodiments set forth in any previous and/or subsequent figure(s) and/or description thereof. Of course, however, the graph 400 may be implemented in the context of any desired environment. Further, the aforementioned definitions may equally apply to the description below.

As shown, the graph 400 illustrates a line chart graph representing the relationship between binder formulation and adhesion. The binder formulation may include both a polymer binder, such as LiPAA, and a fiber, such as MFC. The plot demonstrates that the amount of a polymer binder and fiber may influence the adhesion properties of the electrode.

In particular, the graph 400 shows a progressive increase of MFC and decrease of LiPAA, which corresponds with an increasing adhesion amount. Thus, a higher amount of MFC and lower amount of LiPAA is found to have a greater amount of adhesion, compared to a lower amount of MFC and higher amount of LiPAA.

It is noted that adhesion strength is measured in FIGS. 3 and 4 in Newtons (N). The x-axis of the graph may represent the binder formulation, which may vary the percentage of microfibrillated cellulose (MFC) and partially lithiated polyacrylic acid (LiPAA). The y-axis of the graph may quantify the adhesion strength.

The graph 400 demonstrates the effect of the binder composition on the adhesion properties of the material. It is recognized that the binder formulation may include a higher percentage of MFC and a lower percentage of LiPAA, or vice versa. The specific ratio of MFC to LiPAA in the binder formulation may be adjusted based on the desired adhesion properties of the electrode.

In some embodiments, the binder formulation may be optimized to achieve a balance between the adhesion strength and the content of the active material in the electrode. This may involve adjusting the percentages of MFC and LiPAA in the binder formulation to achieve a desired level of adhesion strength without compromising the content of the active material.

In other embodiments, the binder formulation may be selected to maximize the adhesion strength while maintaining a sufficient content of the active material in the electrode. This may involve selecting a binder formulation with a high percentage of MFC and a low percentage of LiPAA, or vice versa, depending on the specific requirements of the electrochemical cell.

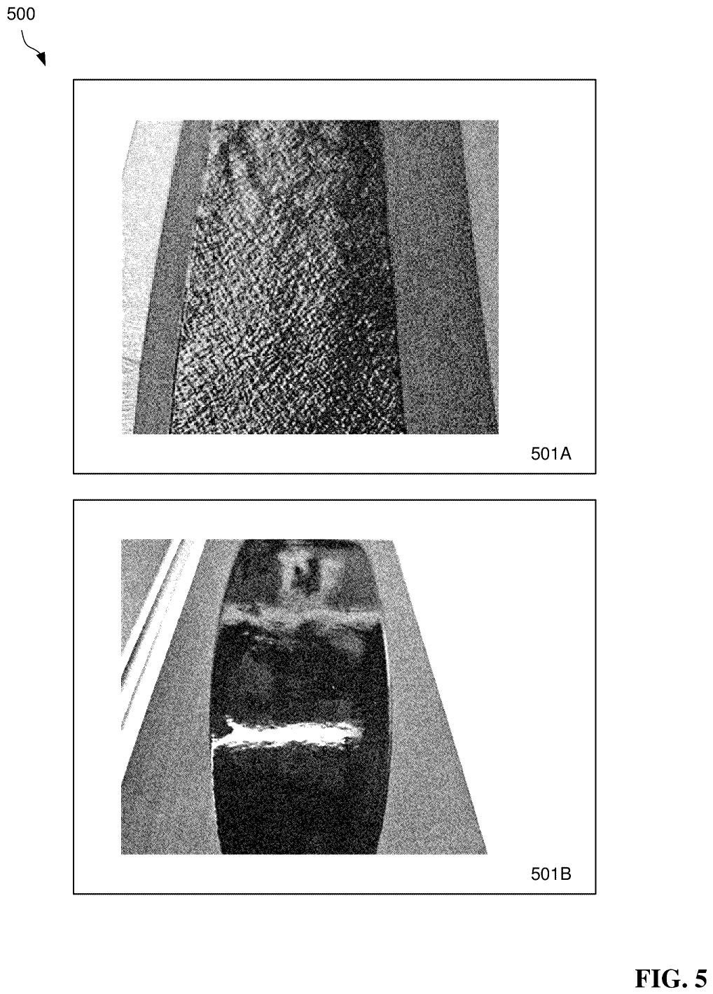

FIG. 5 illustrates surface views 500, in accordance with one embodiment. As an option, the surface views 500 may be implemented in the context of any one or more of the embodiments set forth in any previous and/or subsequent figure(s) and/or description thereof. Of course, however, the surface views 500 may be implemented in the context of any desired environment. Further, the aforementioned definitions may equally apply to the description below.

To understand the context of the surface views 500, one may hypothesize that, based on the graph 400, the inclusion of LiPAA may not be necessary for achieving high adhesion. With that context in place, the surface views 500 include a first view 501A and a second view 501B. The first view 501A represents a coating with MFC (but no LiPAA), and the second view 501B represents a coating with MFC and LiPAA. As shown, the second view 501B represents an ideal coating with uniform lamination of the surface. In contrast, the first view 501A represents an inferior coating with a textured surface that is more prone to crack and break.

As such, the surface views 500 emphasize that the inclusion of MFC and LiPAA is necessary to achieve both high adhesion and the desired surface coating quality.

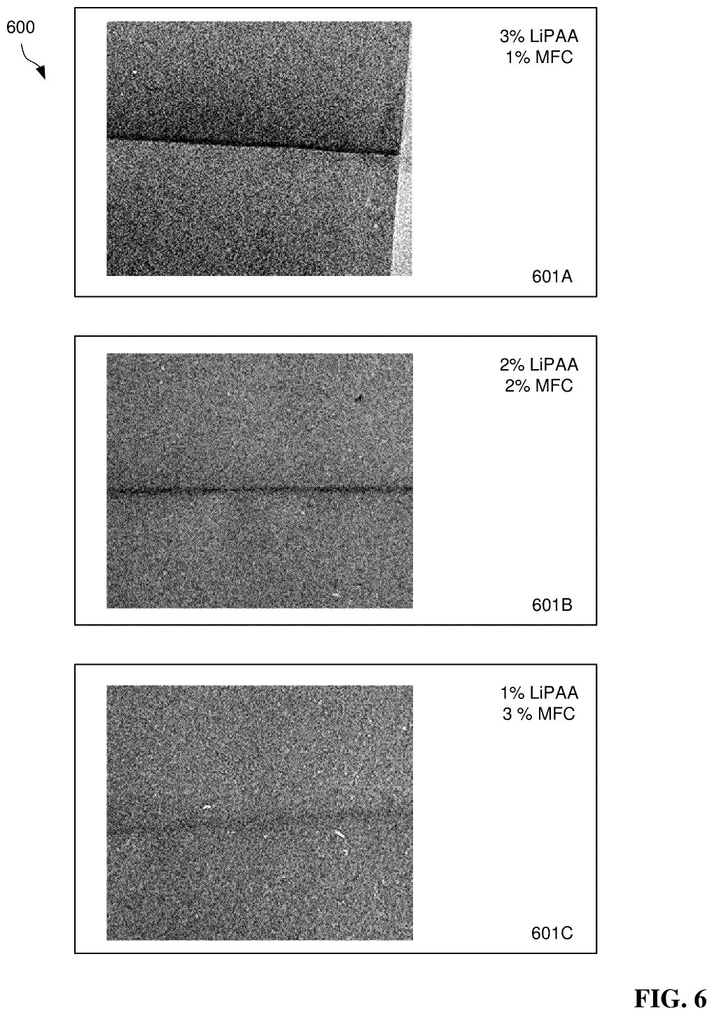

FIG. 6 depicts results 600 of a fold test, in accordance with one embodiment. As an option, the results 600 may be implemented in the context of any one or more of the embodiments set forth in any previous and/or subsequent figure(s) and/or description thereof. Of course, however, the results 600 may be implemented in the context of any desired environment. Further, the aforementioned definitions may equally apply to the description below.

As shown, three results of a fold test are shown in configuration 601A, configuration 601B, and configuration 601C. Configuration 1 601A corresponds with 3% LiPAA and 1% MFC composition. Configuration 2 601B corresponds with 2% LiPAA and 2% MFC composition. Further, configuration 3 601C corresponds with 1% LiPAA and 3% MFC composition.

It is noted that the fold test may be used to test cohesion strength of a cathode. In comparing the results 600, it is noted that as the amount of MFC increases, there is less likelihood of a crack folding (as a result of the fold test). With respect to configuration 1 601A and configuration 2 601B, each visibly show a distinct crack that has formed within the material. Configuration 3 601C in particular shows a fold line but not as distinct of a crack. As such, the configuration 3 601C has less of a crack compared to the configuration 1 601A and the configuration 2 601B.

A significant conclusion from these tests is that the greater the amount of MFC, the greater the cohesion and the less likely a crack will form in the electrode.

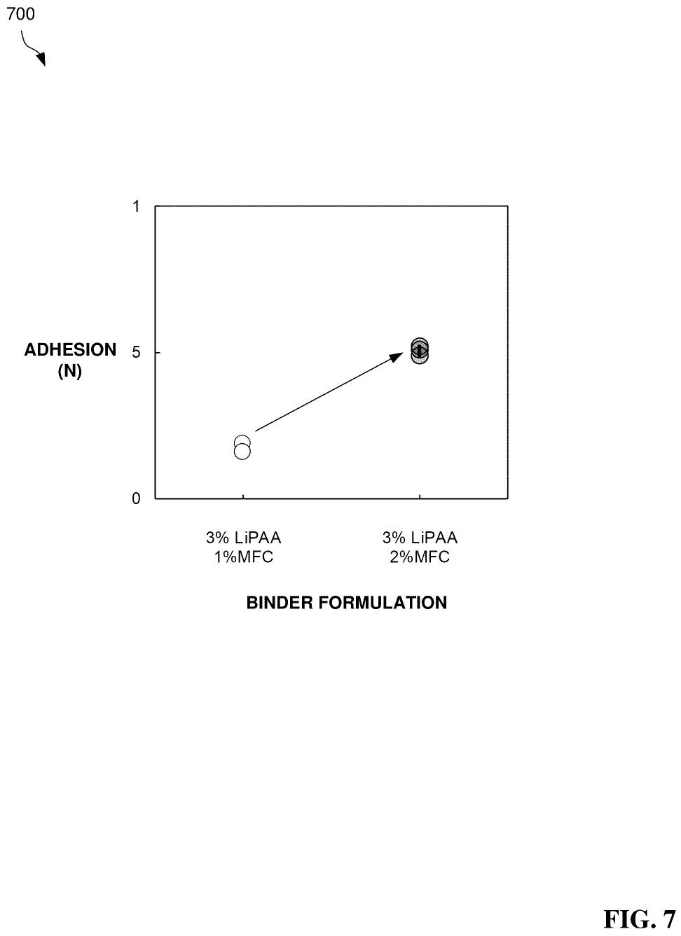

FIG. 7 illustrates a graph 700 representing the relationship between binder formulation and adhesion, in accordance with one embodiment. As an option, the graph 700 may be implemented in the context of any one or more of the embodiments set forth in any previous and/or subsequent figure(s) and/or description thereof. Of course, however, the graph 700 may be implemented in the context of any desired environment. Further, the aforementioned definitions may equally apply to the description below.

As shown, the graph 700 shows a relationship between binder formulation and adhesion is depicted. In some aspects, the adhesion data points may demonstrate the adhesion performance of two formulations: one with 3% LiPAA and 1% MFC, and another with 3% LiPAA and 2% MFC. In some cases, the latter formulation may show a higher adhesion value, suggesting that increasing the MFC content while maintaining a constant LiPAA percentage may enhance the adhesion strength of the electrode.

In other embodiments, the binder formulation may include different ratios of LiPAA to MFC. For instance, the binder formulation may include a higher percentage of LiPAA and a lower percentage of MFC, or vice versa. The specific ratio of LiPAA to MFC in the binder formulation may be adjusted based on the desired adhesion properties of the electrode. This may involve selecting a binder formulation with a high percentage of MFC and a low percentage of LiPAA, or a binder formulation with a high percentage of LiPAA and a low percentage of MFC, depending on the specific requirements of the electrochemical cell.

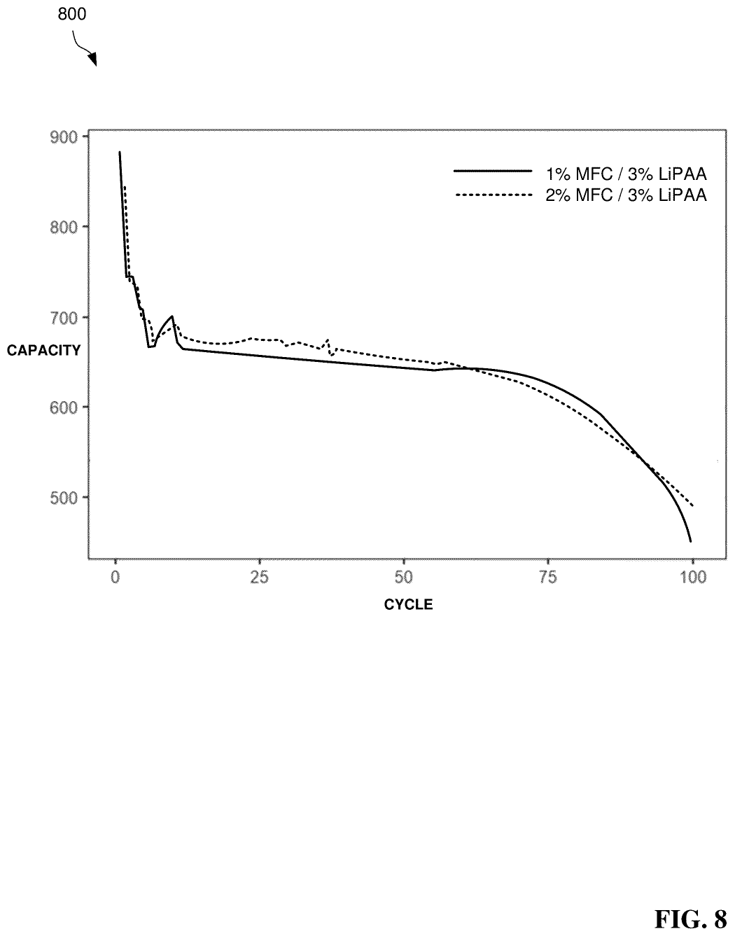

FIG. 8 shows a graph 800 illustrating battery capacity over a number of charge-discharge cycles, in accordance with one embodiment. As an option, the graph 800 may be implemented in the context of any one or more of the embodiments set forth in any previous and/or subsequent figure(s) and/or description thereof. Of course, however, the graph 800 may be implemented in the context of any desired environment. Further, the aforementioned definitions may equally apply to the description below.

As shown, the graph 800 represents battery capacity over a number of charge-discharge cycles. The y-axis represents capacity levels may correspond to the battery's capacity in milliampere-hours (mAh/g), and the x-axis represents discharge cycles. As shown, the solid represents a composition of 1% MFC and 3% LiPAA, and the dotted line represents a composition of 2% MFC and 3% LiPAA.

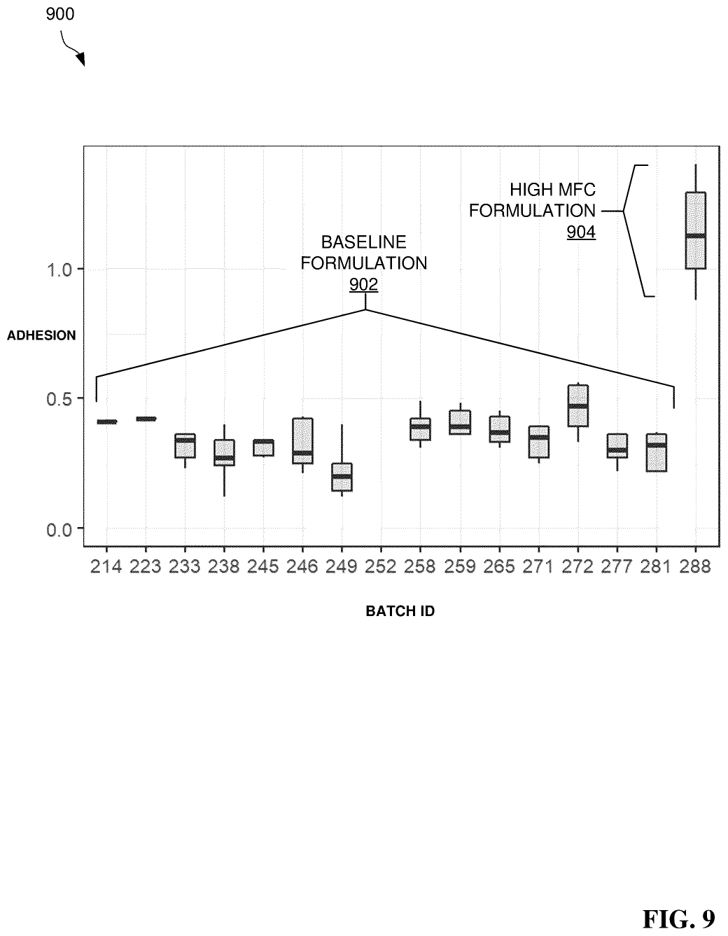

FIG. 9 illustrates a graph 900 illustrating the adhesion properties of different cathode formulations, in accordance with one embodiment. As an option, the graph 900 may be implemented in the context of any one or more of the embodiments set forth in any previous and/or subsequent figure(s) and/or description thereof. Of course, however, the graph 900 may be implemented in the context of any desired environment. Further, the aforementioned definitions may equally apply to the description below.

As shown, the graph 900 illustrates the adhesion values of different cathode formulations is depicted. The baseline formulation line 902 represents a composition of LiPAA with a lower amount of MFC (such as that shown in the graph 700 with a initial composition of 3% LiPAA and 1% MFC). Additionally, the high MFC formulation 904 represents a composition of LiPAA with a higher amount of MFC (as that shown in the graph 700 with a second composition of 3% LiPAA and 2% MFC).

The graph 900 emphasizes that the high MFC formulation 904 has an adhesion value that is higher than the baseline formulation 902.

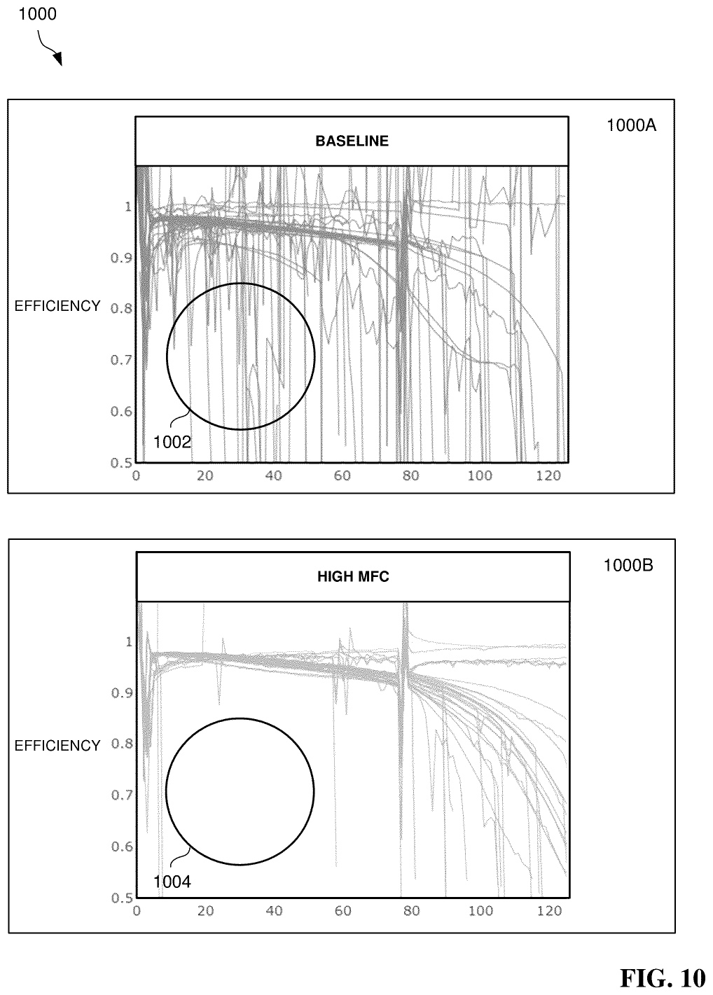

FIG. 10 presents graphs 1000 comparing the efficiency of two different cathode compositions in battery cells, in accordance with one embodiment. As an option, the graphs 1000 may be implemented in the context of any one or more of the embodiments set forth in any previous and/or subsequent figure(s) and/or description thereof. Of course, however, the graphs 1000 may be implemented in the context of any desired environment. Further, the aforementioned definitions may equally apply to the description below.

As shown, the graph 1000 include a baseline graph 1000A and a high MFC graph 1000B. Additionally, and in particular, the baseline graph 1000A shows an area of interest 1002, and the high MFC graph 1000B shows an area of interest 1004. The y-axis for the baseline graph 100A and the high MFC graph 100B represents efficiency, and the x—as represents cycles.

In comparing the area of interest 1002 to the area of interest 1004, it is noted that an electrode composition having a higher MFC amount (compared to a baseline amount) retains a higher efficiency for a greater number of cycles. In particular, a baseline configuration (of the baseline graph 1000A) shows an early cycle fail rate, which early cycle fail rate is eliminated in the higher MFC configuration (of the high MFC graph 1000B).

As such, an increase of MFC provides a more consistent performance of battery efficiency over the same number of cycles (compared to a baseline configuration without higher amounts of MFC). As such, an increase of MFC in the cathode composition may contribute to better efficiency retention in battery cells. Additionally, high MFC composition may show a significant reduction in soft-short failures. Further, increased MFC configuration may enhance adhesion/cohesion, preventing delamination in the electrode.

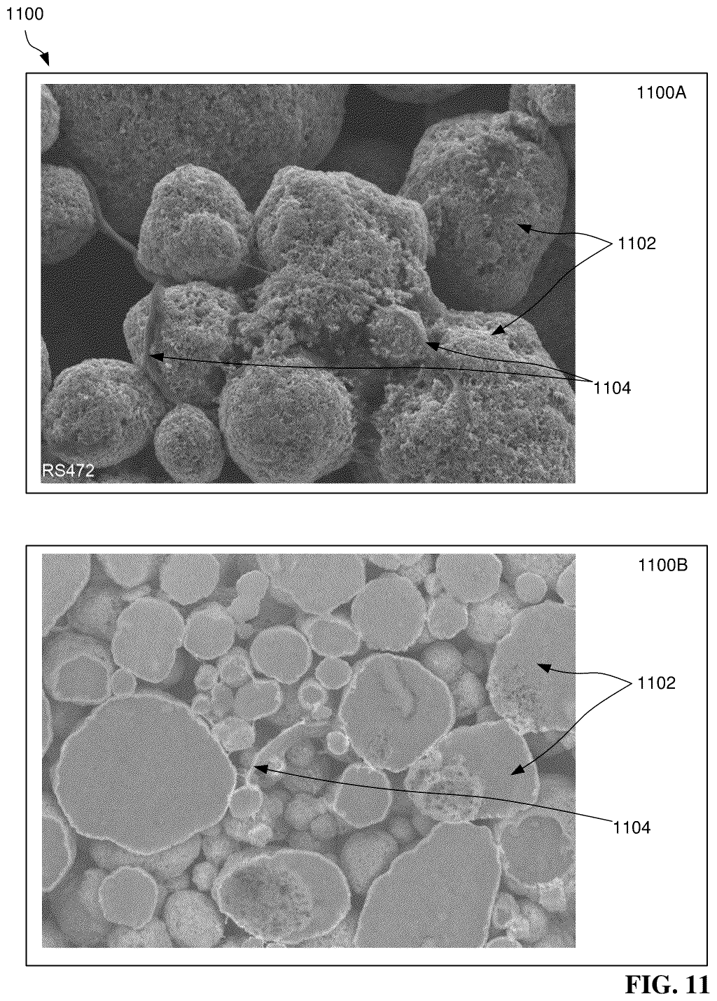

FIG. 11 illustrates micrographs 1100 showing different particle morphologies, in accordance with one embodiment. As an option, the micrographs 1100 may be implemented in the context of any one or more of the embodiments set forth in any previous and/or subsequent figure(s) and/or description thereof. Of course, however, the micrographs 1100 may be implemented in the context of any desired environment. Further, the aforementioned definitions may equally apply to the description below.

As shown, the micrographs 1100 include a first SEM image 1100A and a second SEM image 1100B. The micrographs 1100 display particles 1102 and fiber 1104. In one embodiment, LiPAA may coat the outside of the particles 1102 (which may be spray-dried). Additionally, the fiber 1104 may include MFC and may form a fibrous network that holds the particles 1102 together (for example, at least two fibrous strands can be seen in 1100A, and a number of fibrous strands can be seen in 1100B). In this manner, the cathode may be strengthened by inclusion of MFC. Additionally, as discussed herein, inclusion of the LiPAA binder polymer assists with creating a desired texture for the resulting coating.

It is to be appreciated that a cathode may yield many benefits, as discussed and disclosed herein, based on inclusion of MFC. For example, the fibrous network may prevent particle settling, increase casting of the slurries (due to shear thinning properties of the MFC), reduce mud-cracking tendencies (when drying film), increase strength and flexibility to binder formulations, and/or improve temperature resistance (such as increasing melting point to 260-270° C.).

With respect to MFC, it is to be appreciated that the fibers may be of any specific configuration, but generally may be 9-20 μm in length and 2-20 nm in diameter. Further, the fibers may form a strong 3D structure (due to the entangling of the fibers with the surrounding particles).

Such a 3D structure may be built using the fibrous network of the MFC fibers. For example, MFC (and other fibrous components) include fine and irregular surfaces which allow them to interlock with one another (and other surrounding particles) when arranged in a non-linear manner, forming a web-like network resistant to deformation. Additionally, the small size and flexibility of microfibers enable them to become entangled with each other (and surrounding particles) upon introduction into a space, further reinforcing the structure's stability. Moreover, the high surface area-to-volume ratio of microfibers may facilitate extensive interaction between fibers and surrounding materials, enhancing the overall stability of the structure.

In some cases, microfibers can be chemically or physically bonded (to each other, to surrounding particles, etc.) through cross-linking, preventing individual fibers from moving independently and bolstering the structure's integrity. Furthermore, the microfibers may facilitate capillary action, drawing liquids into the spaces between fibers and providing additional support to prevent collapse. In this manner, a 3D structure may be created (inherently) by including MFC in the binder slurry.

By way of an example (and one possible implementation), MFC may be subjected to high shear mixing using a stator-rotar mixer (e.g., Ultra Turrax, Silverson) to ensure proper dispersion in the slurry. In one embodiment, MFC and LiPAA may be combined using a planetary centrifugal mixer. Further, an active material may be introduced and mixed until a homogeneous slurry is achieved. The slurry may be cast using a doctor blade and dried at 60° C. It is recognized that other implementation are envisioned, and the provided example is not intended to be limiting in any manner.

For example, other possible implementations may include blade/slot-die coatings for slurry casting, use of nanofibrillated cellulose (rather than MFC), a variety of dispersants (other than PAA can be used, such as carboxy-methyl-cellulose (CMC), polyvinyl alcohol (PVA), polyacrylic emulsion (PAE), polyethylene glycol (PEG), etc.).

It is to be appreciated that throughout this disclosure, a significant focus has been on use of MFC within the context of cathode electrodes. However, it is to be appreciated that such applicability may apply to other similar options, such as nanofibrillated cellulose. Thus, where a specific teaching recites MFC, it is to be appreciated that other options, such as nanofibrillated cellulose, should likewise be considered and applied.

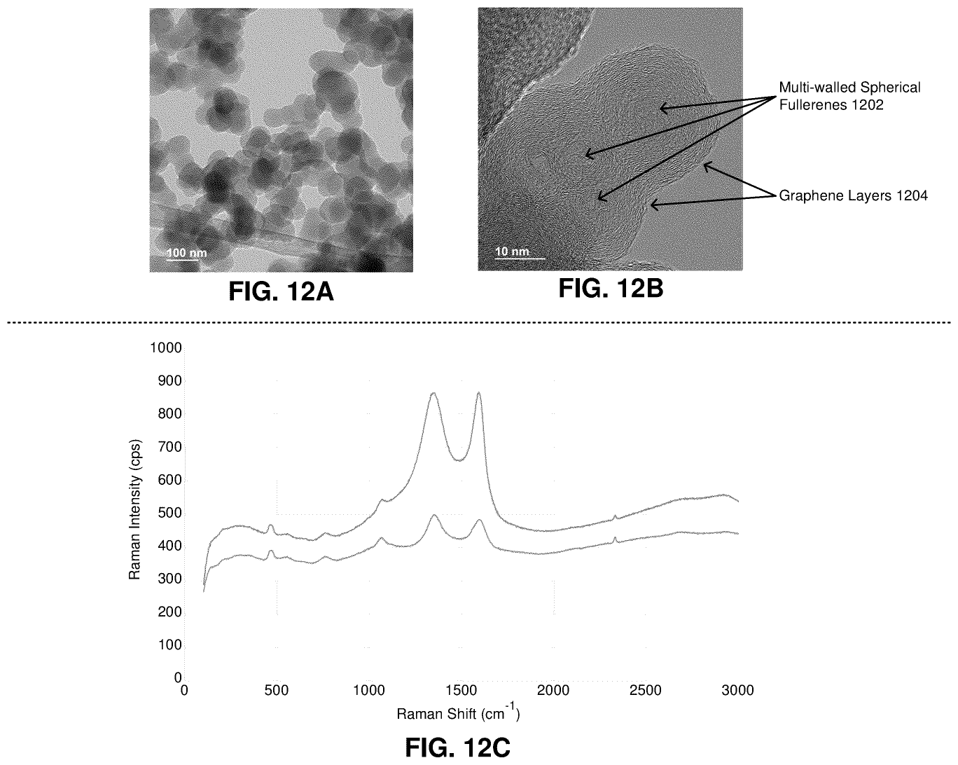

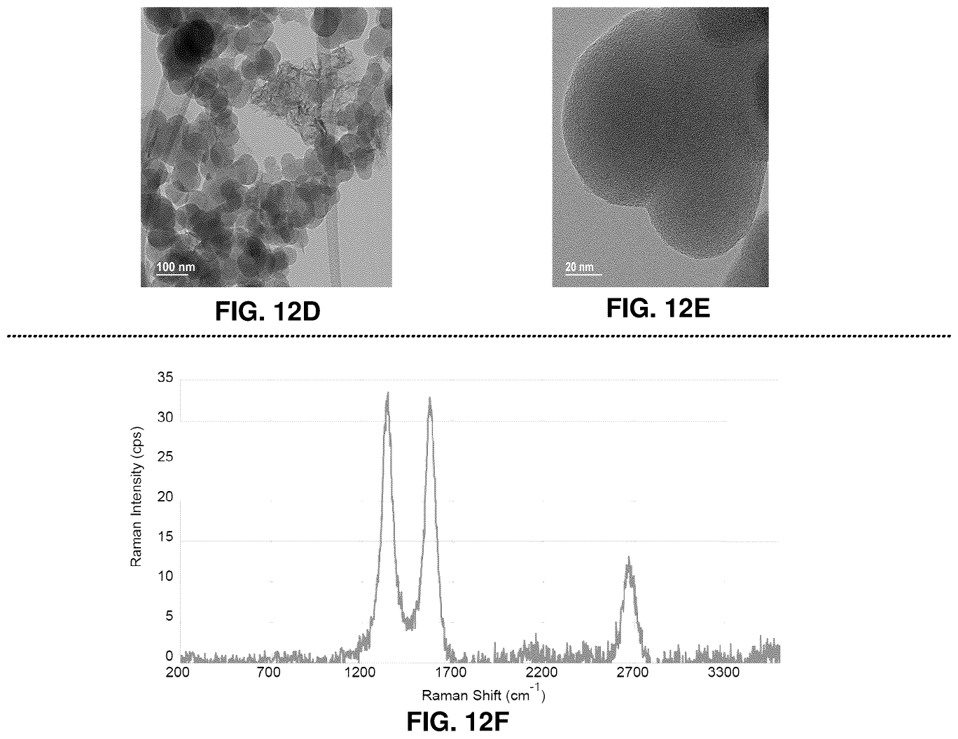

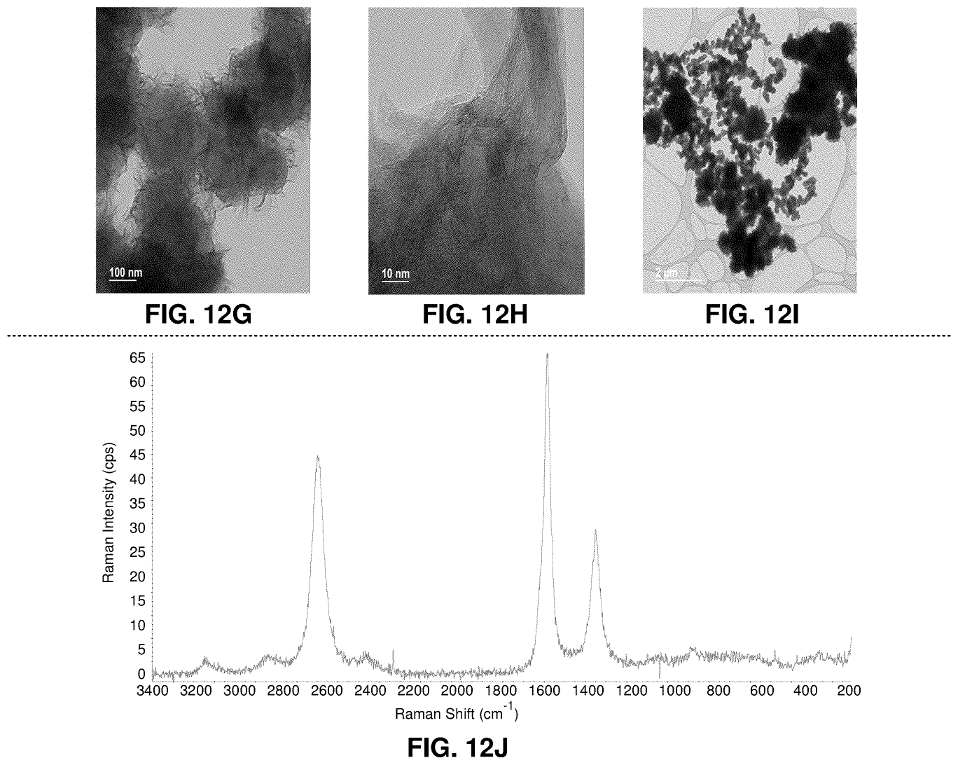

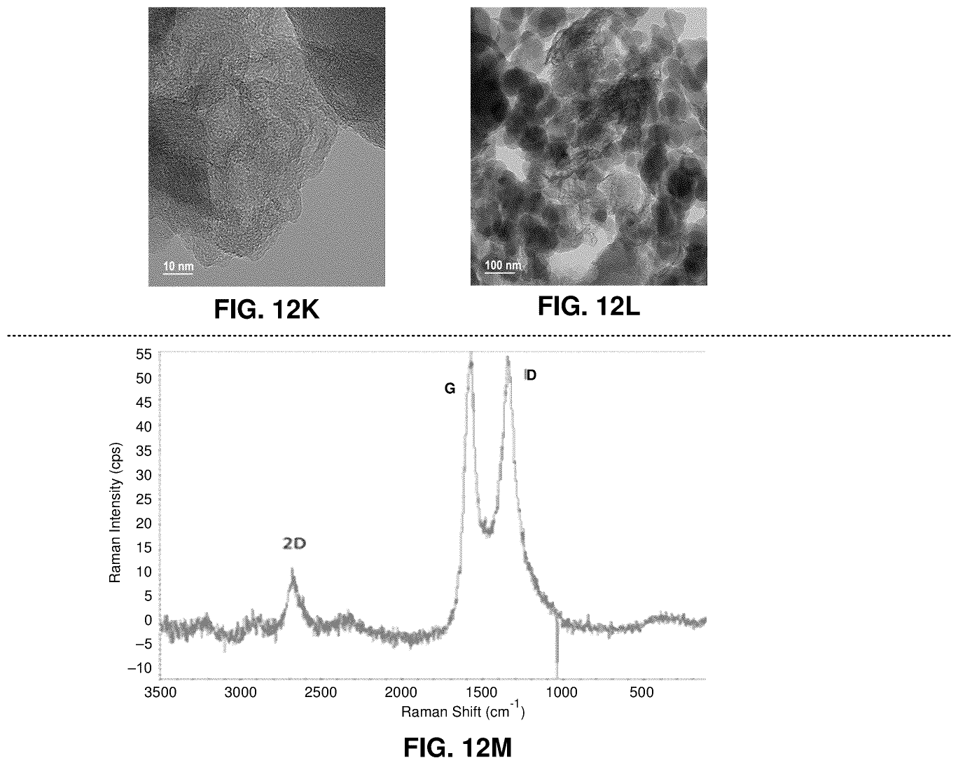

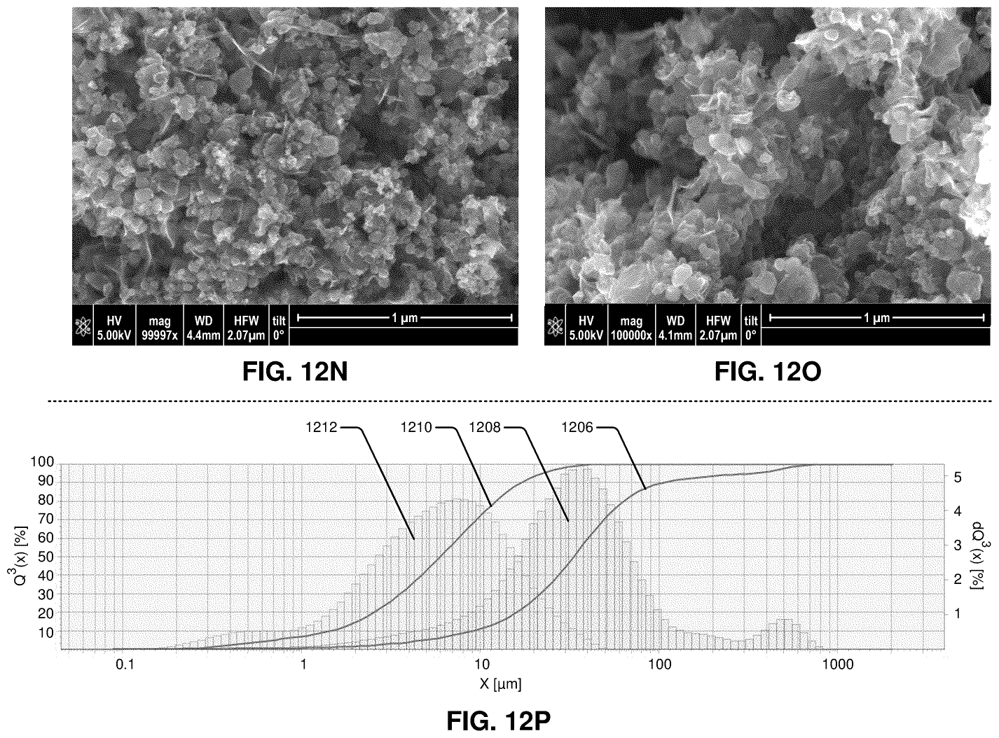

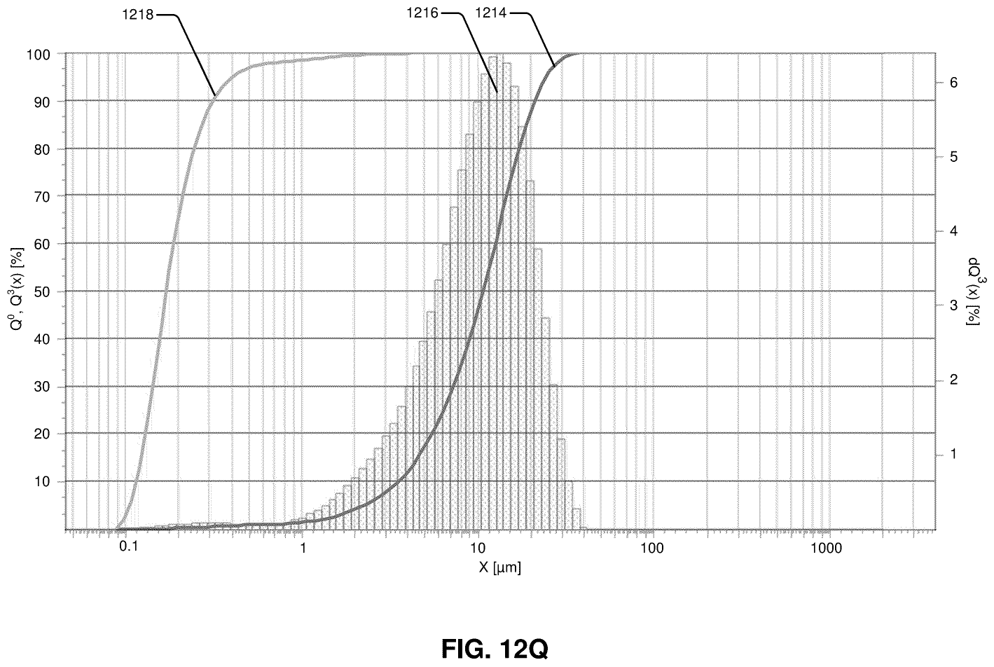

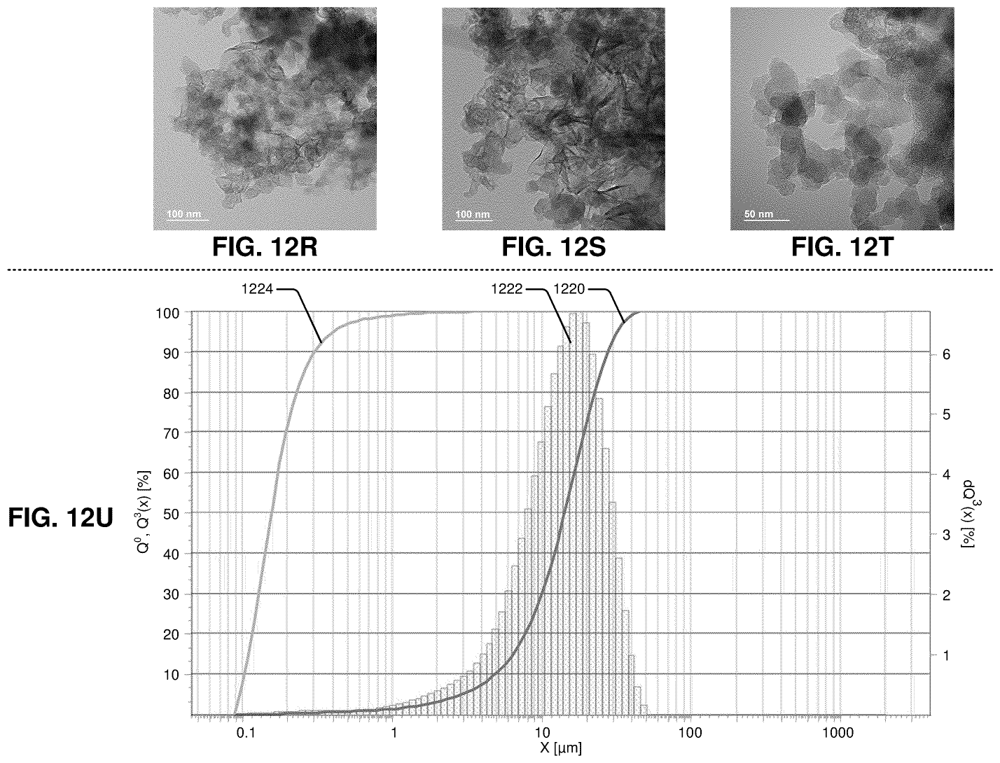

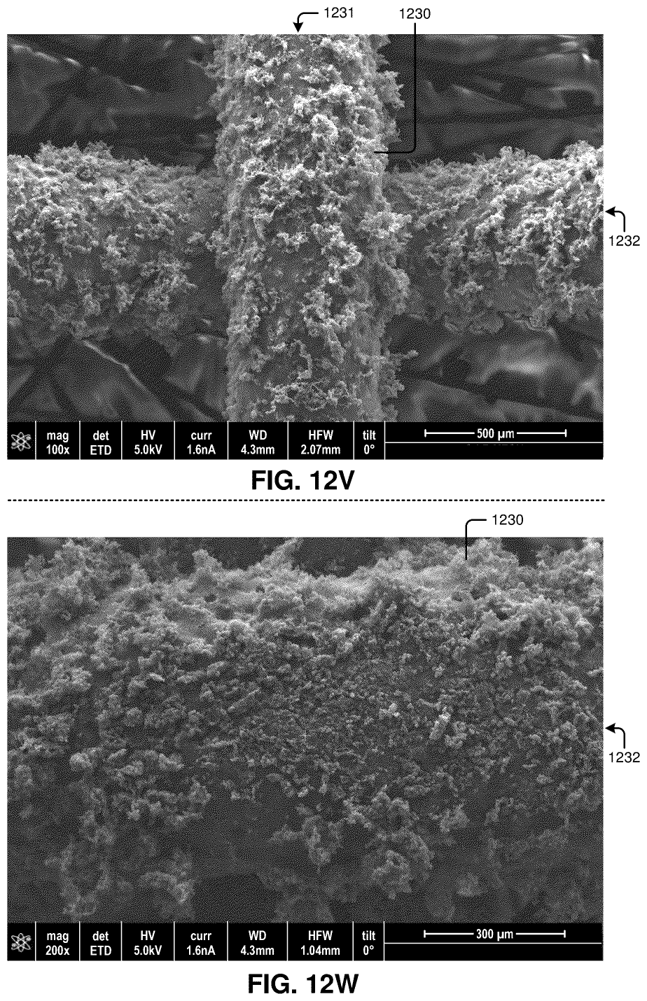

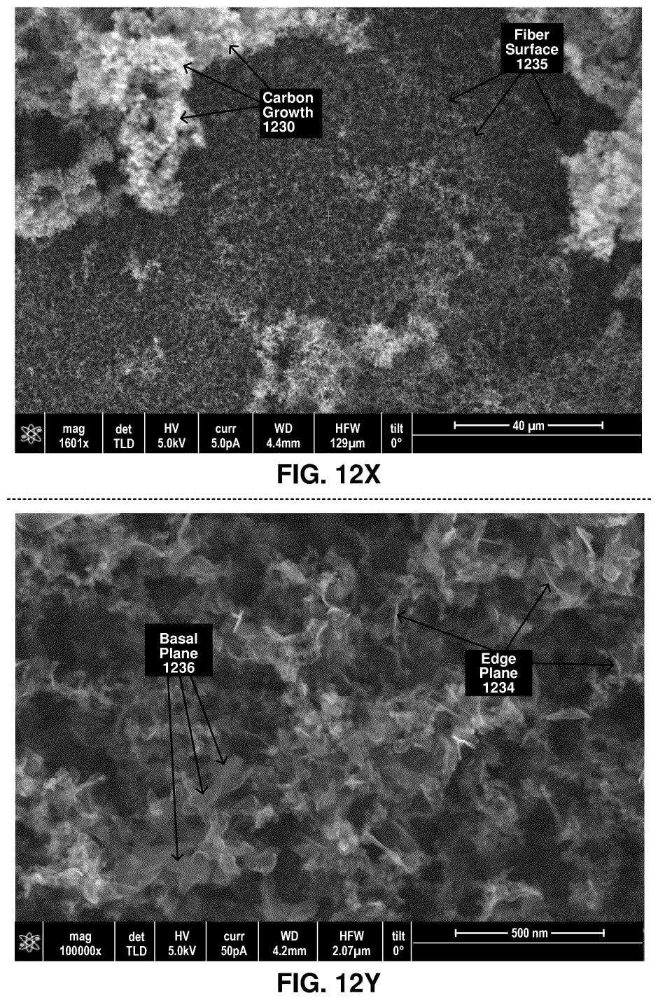

FIG. 12A through FIG. 12Y depict structured carbons, various carbon nanoparticles, various carbon-containing aggregates, and various three-dimensional carbon-containing structures that are grown over other materials, according to some embodiments of the present disclosure.

In some embodiments, the carbon nanoparticles and aggregates are characterized by a high “uniformity” (i.e., high mass fraction of desired carbon allotropes), a high degree of “order” (i.e., low concentration of defects), and/or a high degree of “purity” (i.e., low concentration of elemental impurities), in contrast to the lower uniformity, less ordered, and lower purity particles achievable with conventional systems and methods.

In some embodiments, the nanoparticles produced using the methods described herein contain multi-walled spherical fullerenes (MWSFs) or connected MWSFs and have a high uniformity (e.g., a ratio of graphene to MWSF from 20% to 80%), a high degree of order (e.g., a Raman signature with an I_{D}/I_{G} ratio from 0.95 to 1.05), and a high degree of purity (e.g., the ratio of carbon to other elements (other than hydrogen) is greater than 99.9%). In some embodiments, the nanoparticles produced using the methods described herein contain MWSFs or connected MWSFs, and the MWSFs do not contain a core composed of impurity elements other than carbon. In some cases, the particles produced using the methods described herein are aggregates containing the nanoparticles described above with large diameters (e.g., greater than 10 μm across).

Conventional methods have been used to produce particles containing multi-walled spherical fullerenes with a high degree of order, but the conventional methods lead to carbon products with a variety of shortcomings. For example, high temperature synthesis techniques lead to particles with a mixture of many carbon allotropes and therefore low uniformity (e.g., less than 20% fullerenes to other carbon allotropes) and/or small particle sizes (e.g., less than lum, or less than 100 nm in some cases). Methods using catalysts lead to products including the catalyst elements and therefore have low purity (e.g., less than 95% carbon to other elements) as well. These undesirable properties also often lead to undesirable electrical properties of the resulting carbon particles (e.g., electrical conductivity of less than 1000 S/m).

In some embodiments, the carbon nanoparticles and aggregates described herein are characterized by Raman spectroscopy that is indicative of the high degree of order and uniformity of structure. In some embodiments, the uniform, ordered and/or pure carbon nanoparticles and aggregates described herein are produced using relatively high speed, low cost improved thermal reactors and methods, as described below. Additional advantages and/or improvements will also become apparent from the following disclosure.

In the present disclosure, the term “graphene” refers to an allotrope of carbon in the form of a two-dimensional, atomic-scale, hexagonal lattice in which one atom forms each vertex. The carbon atoms in graphene are sp²-bonded. Additionally, graphene has a Raman spectrum with two main peaks: a G-mode at approximately 1580 cm⁻¹ and a D-mode at approximately 1350 cm⁻¹ (when using a 532 nm excitation laser).

In the present disclosure, the term “fullerene” refers to a molecule of carbon in the form of a hollow sphere, ellipsoid, tube, or other shapes. Spherical fullerenes can also be referred to as Buckminsterfullerenes, or buckyballs. Cylindrical fullerenes can also be referred to as carbon nanotubes. Fullerenes are similar in structure to graphite, which is composed of stacked graphene sheets of linked hexagonal rings. Fullerenes may also contain pentagonal (or sometimes heptagonal) rings.

In the present disclosure, the term “multi-walled fullerene” refers to fullerenes with multiple concentric layers. For example, multi-walled nanotubes (MWNTs) contain multiple rolled layers (concentric tubes) of graphene. Multi-walled spherical fullerenes (MWSFs) contain multiple concentric spheres of fullerenes.

In the present disclosure, the term “nanoparticle” refers to a particle that measures from 1 nm to 989 nm. The nanoparticle can include one or more structural characteristics (e.g., crystal structure, defect concentration, etc.), and one or more types of atoms. The nanoparticle can be any shape, including but not limited to spherical shapes, spheroidal shapes, dumbbell shapes, cylindrical shapes, elongated cylindrical type shapes, rectangular prism shapes, disk shapes, wire shapes, irregular shapes, dense shapes (i.e., with few voids), porous shapes (i.e., with many voids), etc.

In the present disclosure, the term “aggregate” refers to a plurality of nanoparticles that are connected together by electrostatic forces (e.g., Van der Waals forces, London dispersion forces, dipole-dipole interactions, hydrogen bonding, etc.) by covalent bonds, by ionic bonds, by metallic bonds, or by other physical or chemical interactions. Aggregates can vary in size considerably, but in general are larger than about 500 nm.

In some embodiments, a carbon nanoparticle, as described herein, includes two or more connected multi-walled spherical fullerenes (MWSFs) and layers of graphene coating the connected MWSFs. In some embodiments, a carbon nanoparticle, as described herein, includes two or more connected multi-walled spherical fullerenes (MWSFs) and layers of graphene coating the connected MWSFs where the MWSFs do not contain a core composed of impurity elements other than carbon. In some embodiments, a carbon nanoparticle, as described herein, includes two or more connected multi-walled spherical fullerenes (MWSFs) and layers of graphene coating the connected MWSFs where the MWSFs do not contain a void (i.e., a space with no carbon atoms greater than approximately 0.5 nm, or greater than approximately 1 nm) at the center. In some embodiments, the connected MWSFs are formed of concentric, well-ordered spheres of sp²-hybridized carbon atoms, as contrasted with spheres of poorly-ordered, non-uniform, amorphous carbon particles.

In some embodiments, the nanoparticles containing the connected MWSFs have an average diameter in a range from 5 to 500 nm, or from 5 to 250 nm, or from 5 to 100 nm, or from 5 to 50 nm, or from 10 to 500 nm, or from 10 to 250 nm, or from 10 to 100 nm, or from 10 to 50 nm, or from 40 to 500 nm, or from 40 to 250 nm, or from 40 to 100 nm, or from 50 to 500 nm, or from 50 to 250 nm, or from 50 to 100 nm. Of course, nanoparticles containing connected MWSFs may have an average diameter characterized by having any of the foregoing values or being within any of the foregoing exemplary ranges, or an average diameter characterized by having a value or being within a range between any of the foregoing exemplary ranges, without limitation and without departing from the scope of the presently described inventive concepts.

In some embodiments, the carbon nanoparticles described herein form aggregates, wherein many nanoparticles aggregate together to form a larger unit. In some embodiments, a carbon aggregate includes a plurality of carbon nanoparticles. A diameter across the carbon aggregate is in a range from 10 to 500 μm, or from 50 to 500 μm, or from 100 to 500 μm, or from 250 to 500 μm, or from 10 to 250 μm, or from 10 to 100 μm, or from 10 to 50 μm. Of course, carbon aggregates may have an average diameter characterized by having any of the foregoing values or being within any of the foregoing exemplary ranges, or an average diameter characterized by having a value or being within a range between any of the foregoing exemplary ranges, without limitation and without departing from the scope of the presently described inventive concepts.

In some embodiments, the aggregate is formed from a plurality of carbon nanoparticles, as defined above. In some embodiments, aggregates contain connected MWSFs. In some embodiments, the aggregates contain connected MWSFs with a high uniformity metric (e.g., a ratio of graphene to MWSF from 20% to 80%), a high degree of order (e.g., a Raman signature with an I_{D}/I_{G} ratio from 0.95 to 1.05), and a high degree of purity (e.g., greater than 99.9% carbon).

One benefit of producing aggregates of carbon nanoparticles, particularly with diameters in the ranges described above, is that aggregates of particles greater than 10 μm are easier to collect than particles or aggregates of particles that are smaller than 500 nm. The ease of collection reduces the cost of manufacturing equipment used in the production of the carbon nanoparticles and increases the yield of the carbon nanoparticles. Additionally, particles greater than 10 μm in size pose fewer safety concerns compared to the risks of handling smaller nanoparticles, e.g., potential health and safety risks due to inhalation of the smaller nanoparticles. The lower health and safety risks, thus, further reduce the manufacturing cost.

In some embodiments, a carbon nanoparticle has a ratio of graphene to MWSFs from 10% to 90%, or from 10% to 80%, or from 10% to 60%, or from 10% to 40%, or from 10% to 20%, or from 20% to 40%, or from 20% to 90%, or from 40% to 90%, or from 60% to 90%, or from 80% to 90%. In some embodiments, a carbon aggregate has a ratio of graphene to MWSFs is from 10% to 90%, or from 10% to 80%, or from 10% to 60%, or from 10% to 40%, or from 10% to 20%, or from 20% to 40%, or from 20% to 90%, or from 40% to 90%, or from 60% to 90%, or from 80% to 90%. Of course, carbon nanoparticles may have a graphene-to-MWSF ratio characterized by having any of the foregoing values or being within any of the foregoing exemplary ranges, or an average graphene-to-MWSF ratio characterized by having a value or being within a range between any of the foregoing exemplary ranges, without limitation and without departing from the scope of the presently described inventive concepts.

In some embodiments, a carbon nanoparticle has a ratio of graphene to connected MWSFs from 10% to 90%, or from 10% to 80%, or from 10% to 60%, or from 10% to 40%, or from 10% to 20%, or from 20% to 40%, or from 20% to 90%, or from 40% to 90%, or from 60% to 90%, or from 80% to 90%. In some embodiments, a carbon aggregate has a ratio of graphene to connected MWSFs is from 10% to 90%, or from 10% to 80%, or from 10% to 60%, or from 10% to 40%, or from 10% to 20%, or from 20% to 40%, or from 20% to 90%, or from 40% to 90%, or from 60% to 90%, or from 80% to 90%. Of course, carbon nanoparticles may have a graphene-to-connected MWSF ratio characterized by having any of the foregoing values or being within any of the foregoing exemplary ranges, or an average graphene-to-connected MWSF ratio characterized by having a value or being within a range between any of the foregoing exemplary ranges, without limitation and without departing from the scope of the presently described inventive concepts.

In some embodiments, Raman spectroscopy is used to characterize carbon allotropes to distinguish their molecular structures. For example, graphene can be characterized using Raman spectroscopy to determine information such as order/disorder, edge and grain boundaries, thickness, number of layers, doping, strain, and thermal conductivity. MWSFs have also been characterized using Raman spectroscopy to determine the degree of order of the MWSFs.

In some embodiments, Raman spectroscopy is used to characterize the structure of MWSFs or connected MWSFs. The main peaks in the Raman spectra are the G-mode and the D-mode. The G-mode is attributed to the vibration of carbon atoms in sp²-hybridized carbon networks, and the D-mode is related to the breathing of hexagonal carbon rings with defects. In some cases, defects may be present, yet may not be detectable in the Raman spectra. For example, if the presented crystalline structure is orthogonal with respect to the basal plane, the D-peak will show an increase. On the other hand, if presented with a perfectly planar surface that is parallel with respect to the basal plane, the D-peak will be zero.

When using 532 nm incident light, the Raman G-mode is typically at 1582 cm⁻¹ for planar graphite, however can be downshifted for MWSFs or connected MWSFs (e.g., down to 1565 cm⁻¹ or down to 1580 cm⁻¹). The D-mode is observed at approximately 1350 cm⁻¹ in the Raman spectra of MWSFs or connected MWSFs. The ratio of the intensities of the D-mode peak to G-mode peak (i.e., the I_{D}/I_{G}) is related to the degree of order of the MWSFs, where a lower I_{D}/I_{G} indicates a higher degree of order. An I_{D}/I_{G} near or below 1 indicates a relatively high degree of order, and an I_{D}/I_{G} greater than 1.1 indicates a lower degree of order.

In some embodiments, a carbon nanoparticle or a carbon aggregate containing MWSFs or connected MWSFs, as described herein, has a Raman spectrum with a first Raman peak at about 1350 cm⁻¹ and a second Raman peak at about 1580 cm⁻¹ when using 532 nm incident light. In some embodiments, the ratio of an intensity of the first Raman peak to an intensity of the second Raman peak (i.e., the I_{D}/I_{G}) for the nanoparticles or the aggregates described herein is in a range from 0.95 to 1.05, or from 0.9 to 1.1, or from 0.8 to 1.2, or from 0.9 to 1.2, or from 0.8 to 1.1, or from 0.5 to 1.5, or less than 1.5, or less than 1.2, or less than 1.1, or less than 1, or less than 0.95, or less than 0.9, or less than 0.8. Of course, carbon nanoparticles or aggregates including MWSFs or connected MWSFs may be characterized by a ratio of first and second Raman peak intensities having any of the foregoing values or being within any of the foregoing exemplary ranges, or a ratio of first and second Raman peak intensities characterized by having a value or being within a range between any of the foregoing exemplary ranges, without limitation and without departing from the scope of the presently described inventive concepts.

In some embodiments, a carbon aggregate containing MWSFs or connected MWSFs, as defined above, has a high purity. In some embodiments, the carbon aggregate containing MWSFs or connected MWSFs has a ratio of carbon to metals of greater than 99.99%, or greater than 99.95%, or greater than 99.9%, or greater than 99.8%, or greater than 99.5%, or greater than 99%. In some embodiments, the carbon aggregate has a ratio of carbon to other elements of greater than 99.99%, or greater than 99.95%, or greater than 99.9%, or greater than 99.5%, or greater than 99%, or greater than 90%, or greater than 80%, or greater than 70%, or greater than 60%. In some embodiments, the carbon aggregate has a ratio of carbon to other elements (except for hydrogen) of greater than 99.99%, or greater than 99.95%, or greater than 99.9%, or greater than 99.8%, or greater than 99.5%, or greater than 99%, or greater than 90%, or greater than 80%, or greater than 70%, or greater than 60%. Of course, carbon aggregates including MWSFs or connected MWSFs may be characterized by a ratio of carbon to metal having any of the foregoing values or being within any of the foregoing exemplary ranges, or a ratio of carbon to metal having value or being within a range between any of the foregoing exemplary ranges, without limitation and without departing from the scope of the presently described inventive concepts.

In some embodiments, a carbon aggregate containing MWSFs or connected MWSFs, as defined above, has a high specific surface area. In some embodiments, the carbon aggregate has a Brunauer, Emmett and Teller (BET) specific surface area from 10 to 200 m²/g, or from 10 to 100 m²/g, or from 10 to 50 m2/g, or from 50 to 200 m²/g, or from 50 to 100 m²/g, or from 10 to 1000 m²/g. Of course, carbon aggregates including MWSFs or connected MWSFs may be characterized by a BET specific surface area having any of the foregoing values or being within any of the foregoing exemplary ranges, or a BET specific surface area characterized by having a value or being within a range between any of the foregoing exemplary ranges, without limitation and without departing from the scope of the presently described inventive concepts.

In some embodiments, a carbon aggregate containing MWSFs or connected MWSFs, as defined above, has a high electrical conductivity. In some embodiments, a carbon aggregate containing MWSFs or connected MWSFs, as defined above, is compressed into a pellet and the pellet has an electrical conductivity greater than 500 S/m, or greater than 1000 S/m, or greater than 2000 S/m, or greater than 3000 S/m, or greater than 4000 S/m, or greater than 5000 S/m, or greater than 10000 S/m, or greater than 20000 S/m, or greater than 30000 S/m, or greater than 40000 S/m, or greater than 50000 S/m, or greater than 60000 S/m, or greater than 70000 S/m, or from 500 S/m to 100000 S/m, or from 500 S/m to 1000 S/m, or from 500 S/m to 10000 S/m, or from 500 S/m to 20000 S/m, or from 500 S/m to 100000 S/m, or from 1000 S/m to 10000 S/m, or from 1000 S/m to 20000 S/m, or from 10000 to 100000 S/m, or from 10000 S/m to 80000 S/m, or from 500 S/m to 10000 S/m. Of course, carbon aggregates including MWSFs or connected MWSFs may be characterized by an electrical conductivity having any of the foregoing values or being within any of the foregoing exemplary ranges, or an electrical conductivity characterized by having a value or being within a range between any of the foregoing exemplary ranges, without limitation and without departing from the scope of the presently described inventive concepts.

In some cases, the density of the pellet is approximately 1 g/cm³, or approximately 1.2 g/cm³, or approximately 1.5 g/cm³, or approximately 2 g/cm³, or approximately 2.2 g/cm³, or approximately 2.5 g/cm³, or approximately 3 g/cm³. Of course, pellets may be characterized by a density having any of the foregoing values or being within any of the foregoing exemplary ranges, or a density having a value or being within a range between any of the foregoing exemplary ranges, without limitation and without departing from the scope of the presently described inventive concepts.

Additionally, tests have been performed in which compressed pellets of the carbon aggregate materials have been formed with compressions of 2000 psi and 12000 psi and with annealing temperatures of 800° C. and 1000° C. The higher compression and/or the higher annealing temperatures generally result in pellets with a higher degree of electrical conductivity, including in the range of 12410.0 S/m to 13173.3 S/m.

### High Purity Carbon Allotropes Produced Using Thermal Processing Systems

In some embodiments, the carbon nanoparticles and aggregates described herein are produced using thermal reactors and methods, such as any appropriate thermal reactor and/or method. Further details pertaining to thermal reactors and/or methods of use can be found in U.S. Pat. No. 9,862,602, issued Jan. 9, 2018, titled “CRACKING OF A PROCESS GAS”, which is hereby incorporated by reference in its entirety. Additionally, precursors (e.g., including methane, ethane, propane, butane, and natural gas) can be used with the thermal reactors to produce the carbon nanoparticles and the carbon aggregates described herein.

In some embodiments, the carbon nanoparticles and aggregates described herein are produced using the thermal reactors with gas flow rates from 1 slm to 10 slm, or from 0.1 slm to 20 slm, or from 1 slm to 5 slm, or from 5 slm to 10 slm, or greater than 1 slm, or greater than 5 slm. In some embodiments, the carbon nanoparticles and aggregates described herein are produced using the thermal reactors with gas resonance times from 0.1 seconds to 30 seconds, or from 0.1 seconds to 10 seconds, or from 1 seconds to 10 seconds, or from 1 seconds to 5 seconds, from 5 seconds to 10 seconds, or greater than 0.1 seconds, or greater than 1 seconds, or greater than 5 seconds, or less than 30 seconds. Of course, carbon nanoparticles and aggregates may be produced using thermal reactors with gas flow rates having any of the foregoing values or being within any of the foregoing exemplary ranges, or gas flow rates having a value or being within a range between any of the foregoing exemplary ranges, without limitation and without departing from the scope of the presently described inventive concepts.

In some embodiments, the carbon nanoparticles and aggregates described herein are produced using the thermal reactors with production rates from 10 g/hr to 200 g/hr, or from 30 g/hr to 200 g/hr, or from 30 g/hr to 100 g/hr, or from 30 g/hr to 60 g/hr, or from 10 g/hr to 100 g/hr, or greater than 10 g/hr, or greater than 30 g/hr, or greater than 100 g/hr. Of course, carbon nanoparticles and aggregates may be produced using thermal reactors with production rates having any of the foregoing values or being within any of the foregoing exemplary ranges, or production rates having a value or being within a range between any of the foregoing exemplary ranges, without limitation and without departing from the scope of the presently described inventive concepts.

In some embodiments, thermal reactors or other cracking apparatuses and thermal reactor methods or other cracking methods can be used for refining, pyrolizing, dissociating or cracking feedstock process gases into its constituents to produce the carbon nanoparticles and the carbon aggregates described herein, as well as other solid and/or gaseous products (e.g., hydrogen gas and/or lower order hydrocarbon gases). The feedstock process gases generally include, for example, hydrogen gas (H₂), carbon dioxide (CO₂), C₁ to C₁₀ hydrocarbons, aromatic hydrocarbons, and/or other hydrocarbon gases such as natural gas, methane, ethane, propane, butane, isobutane, saturated/unsaturated hydrocarbon gases, ethene, propene, etc., and mixtures thereof. The carbon nanoparticles and the carbon aggregates can include, for example, multi-walled spherical fullerenes (MWSFs), connected MWSFs, carbon nanospheres, graphene, graphite, highly ordered pyrolytic graphite, single-walled nanotubes, multi-walled nanotubes, other solid carbon products, and/or the carbon nanoparticles and the carbon aggregates described herein.

Some embodiments for producing the carbon nanoparticles and the carbon aggregates described herein include thermal cracking methods that use, for example, an elongated longitudinal heating element optionally enclosed within an elongated casing, housing or body of a thermal cracking apparatus. The body generally includes, for example, one or more tubes or other appropriate enclosures made of stainless steel, titanium, graphite, quartz, or the like. In some embodiments, the body of the thermal cracking apparatus is generally cylindrical in shape with a central elongate longitudinal axis arranged vertically and a feedstock process gas inlet at or near a top of the body. The feedstock process gas flows longitudinally down through the body or a portion thereof. In the vertical configuration, both gas flow and gravity assist in the removal of the solid products from the body of the thermal cracking apparatus.

The heating element generally includes, for example, a heating lamp, one or more resistive wires or filaments (or twisted wires), metal filaments, metallic strips or rods, and/or other appropriate thermal radical generators or elements that can be heated to a specific temperature (i.e., a molecular cracking temperature) sufficient to thermally crack molecules of the feedstock process gas. The heating element is generally disposed, located or arranged to extend centrally within the body of the thermal cracking apparatus along the central longitudinal axis thereof. For example, if there is only one heating element, then it is placed at or concentric with the central longitudinal axis, and if there is a plurality of the heating elements, then they are spaced or offset generally symmetrically or concentrically at locations near and around and parallel to the central longitudinal axis.

Thermal cracking to produce the carbon nanoparticles and aggregates described herein is generally achieved by passing the feedstock process gas over, or in contact with, or within the vicinity of, the heating element within a longitudinal elongated reaction zone generated by heat from the heating element and defined by and contained inside the body of the thermal cracking apparatus to heat the feedstock process gas to or at a specific molecular cracking temperature.

The reaction zone is considered to be the region surrounding the heating element and close enough to the heating element for the feedstock process gas to receive sufficient heat to thermally crack the molecules thereof. The reaction zone is thus generally axially aligned or concentric with the central longitudinal axis of the body. In some embodiments, the thermal cracking is performed under a specific pressure. In some embodiments, the feedstock process gas is circulated around or across the outside surface of a container of the reaction zone or a heating chamber in order to cool the container or chamber and preheat the feedstock process gas before flowing the feedstock process gas into the reaction zone.

In some embodiments, the carbon nanoparticles and aggregates described herein and/or hydrogen gas are produced without the use of catalysts. In other words, the process is catalyst free.

Some embodiments to produce the carbon nanoparticles and aggregates described herein using thermal cracking apparatuses and methods to provide a standalone system that can advantageously be rapidly scaled up or scaled down for different production levels as desired. For example, some embodiments are scalable to provide a standalone hydrogen and/or carbon nanoparticle producing station, a hydrocarbon source, or a fuel cell station. Some embodiments can be scaled up to provide higher capacity systems, e.g., for a refinery or the like.

In some embodiments, a thermal cracking apparatus for cracking a feedstock process gas to produce the carbon nanoparticles and aggregates described herein include a body, a feedstock process gas inlet, and an elongated heating element. The body has an inner volume with a longitudinal axis. The inner volume has a reaction zone concentric with the longitudinal axis. A feedstock process gas is flowed into the inner volume through the feedstock process gas inlet during thermal cracking operations. The elongated heating element is disposed within the inner volume along the longitudinal axis and is surrounded by the reaction zone. During the thermal cracking operations, the elongated heating element is heated by electrical power to a molecular cracking temperature to generate the reaction zone, the feedstock process gas is heated by heat from the elongated heating element, and the heat thermally cracks molecules of the feedstock process gas that are within the reaction zone into constituents of the molecules.

In some embodiments, a method for cracking a feedstock process gas to produce the carbon nanoparticles and aggregates described herein includes: (1) providing a thermal cracking apparatus having an inner volume that has a longitudinal axis and an elongated heating element disposed within the inner volume along the longitudinal axis; (2) heating the elongated heating element by electrical power to a molecular cracking temperature to generate a longitudinal elongated reaction zone within the inner volume; (3) flowing a feedstock process gas into the inner volume and through the longitudinal elongated reaction zone (e.g., wherein the feedstock process gas is heated by heat from the elongated heating element); and (4) thermally cracking molecules of the feedstock process gas within the longitudinal elongated reaction zone into constituents thereof (e.g., hydrogen gas and one or more solid products) as the feedstock process gas flows through the longitudinal elongated reaction zone.

In some embodiments, the feedstock process gas to produce the carbon nanoparticles and aggregates described herein includes a hydrocarbon gas. The results of cracking include hydrogen (e.g., H₂) and various forms of the carbon nanoparticles and aggregates described herein. In some embodiments, the carbon nanoparticles and aggregates include two or more MWSFs and layers of graphene coating the MWSFs, and/or connected MWSFs and layers of graphene coating the connected MWSFs. In some embodiments, the feedstock process gas is preheated (e.g., to 100° C. to 500° C.) by flowing the feedstock process gas through a gas preheating region between a heating chamber and a shell of the thermal cracking apparatus before flowing the feedstock process gas into the inner volume. In some embodiments, a gas having nanoparticles therein is flowed into the inner volume and through the longitudinal elongated reaction zone to mix with the feedstock process gas, and a coating of a solid product (e.g., layers of graphene) is formed around the nanoparticles.

### Post-Processing High Purity Structured Carbons

In some embodiments, the carbon nanoparticles and aggregates containing multi-walled spherical fullerenes (MWSFs) or connected MWSFs described herein are produced and collected, and no post-processing is done. In other embodiments, the carbon nanoparticles and aggregates containing multi-walled spherical fullerenes (MWSFs) or connected MWSFs described herein are produced and collected, and some post-processing is done. Some examples of post-processing involved in $AAF_InlineTitle ( ) include mechanical processing such as ball milling, grinding, attrition milling, micro fluidizing, and other techniques to reduce the particle size without damaging the MWSFs. Some further examples of post-processing include exfoliation processes such as sheer mixing, chemical etching, oxidizing (e.g., Hummer method), thermal annealing, doping by adding elements during annealing (e.g., sulfur, nitrogen), steaming, filtering, and lyophilizing, among others. Some examples of post-processing include sintering processes such as spark plasma sintering (SPS), direct current sintering, microwave sintering, and ultraviolet (UV) sintering, which can be conducted at high pressure and temperature in an inert gas. In some embodiments, multiple post-processing methods can be used together or in a series. In some embodiments, the post-processing produces functionalized carbon nanoparticles or aggregates containing multi-walled spherical fullerenes (MWSFs) or connected MWSFs.

In some embodiments, the materials are mixed together in different combinations. In some embodiments, different carbon nanoparticles and aggregates containing MWSFs or connected MWSFs described herein are mixed together before post-processing. For example, different carbon nanoparticles and aggregates containing MWSFs or connected MWSFs with different properties (e.g., different sizes, different compositions, different purities, from different processing runs, etc.) can be mixed together. In some embodiments, the carbon nanoparticles and aggregates containing MWSFs or connected MWSFs described herein can be mixed with graphene to change the ratio of the connected MWSFs to graphene in the mixture. In some embodiments, different carbon nanoparticles and aggregates containing MWSFs or connected MWSFs described herein can be mixed together after post-processing. For example, different carbon nanoparticles and aggregates containing MWSFs or connected MWSFs with different properties and/or different post-processing methods (e.g., different sizes, different compositions, different functionality, different surface properties, different surface areas) can be mixed together.

In some embodiments, the carbon nanoparticles and aggregates described herein are produced and collected, and subsequently processed by mechanical grinding, milling, and/or exfoliating. In some embodiments, the processing (e.g., by mechanical grinding, milling, exfoliating, etc.) reduces the average size of the particles. In some embodiments, the processing (e.g., by mechanical grinding, milling, exfoliating, etc.) increases the average surface area of the particles. In some embodiments, the processing by mechanical grinding, milling and/or exfoliation shears off some fraction of the carbon layers, producing sheets of graphite mixed with the carbon nanoparticles.

In some embodiments, the mechanical grinding or milling is performed using a ball mill, a planetary mill, a rod mill, a shear mixer, a high-shear granulator, an autogenous mill, or other types of machining used to break solid materials into smaller pieces by grinding, crushing or cutting. In some embodiments, the mechanical grinding, milling and/or exfoliating is performed wet or dry. In some embodiments, the mechanical grinding is performed by grinding for some period of time, then idling for some period of time, and repeating the grinding and idling for a number of cycles. In some embodiments, the grinding period is from 1 minute to 20 minutes, or from 1 minute to 10 minutes, or from 3 minutes to 8 minutes, or approximately 3 minutes, or approximately 8 minutes. In some embodiments, the idling period is from 1 minute to 10 minutes, or approximately 5 minutes, or approximately 6 minutes. In some embodiments, the number of grinding and idling cycles is from 1 minute to 100 minutes, or from 5 minutes to 100 minutes, or from 10 minutes to 100 minutes, or from 5 minutes to 10 minutes, or from 5 minutes to 20 minutes. In some embodiments, the total amount of time of grinding and idling is from 10 minutes to 1200 minutes, or from 10 minutes to 600 minutes, or from 10 minutes to 240 minutes, or from 10 minutes to 120 minutes, or from 100 minutes to 90 minutes, or from 10 minutes to 60 minutes, or approximately 90 minutes, or approximately 120 minutes. Of course, grinding, milling, or idling times within the scope of the presently disclosed inventive embodiments may have any of the foregoing values or be within any of the foregoing exemplary ranges, between any of the foregoing exemplary ranges, without limitation and without departing from the scope of the presently described inventive concepts.

In some embodiments, the grinding steps in the cycle are performed by rotating a mill in one direction for a first cycle (e.g., clockwise), and then rotating a mill in the opposite direction (e.g., counterclockwise) for the next cycle. In some embodiments, the mechanical grinding or milling is performed using a ball mill, and the grinding steps are performed using a rotation speed from 100 to 1000 rpm, or from 100 to 500 rpm, or approximately 400 rpm, or any value or range of values therebetween. In some embodiments, the mechanical grinding or milling is performed using a ball mill that uses a milling media with a diameter from 0.1 mm to 20 mm, or from 0.1 mm to 10 mm, or from 1 mm to 10 mm, or approximately 0.1 mm, or approximately 1 mm, or approximately 10 mm, or any value or range of values therebetween. In some embodiments, the mechanical grinding or milling is performed using a ball mill that uses a milling media composed of metal such as steel, an oxide such as zirconium oxide (zirconia), yttria stabilized zirconium oxide, silica, alumina, magnesium oxide, or other hard materials such as silicon carbide or tungsten carbide.

In some embodiments, the carbon nanoparticles and aggregates described herein are produced and collected, and subsequently processed using elevated temperatures such as thermal annealing or sintering. In some embodiments, the processing using elevated temperatures is done in an inert environment such as nitrogen or argon. In some embodiments, the processing using elevated temperatures is done at atmospheric pressure, or under vacuum, or at low pressure. In some embodiments, the processing using elevated temperatures is done at a temperature from 500° C. to 2500° C., or from 500° C. to 1500° C., or from 800° C. to 1500° C., or from 800° C. to 1200° C., or from 800° C. to 1000° C., or from 2000° C. to 2400° C., or approximately 800° C., or approximately 1000° C., or approximately 1500° C., or approximately 2000° C., or approximately 2400° C. Of course, processing using elevated temperatures may be performed at any of the foregoing temperatures, or at a temperature within any of the foregoing exemplary ranges, or between any of the foregoing exemplary ranges, without limitation and without departing from the scope of the presently described inventive concepts.

In some embodiments, the carbon nanoparticles and aggregates described herein are produced and collected, and subsequently, in post processing steps, additional elements or compounds are added to the carbon nanoparticles, thereby incorporating the unique properties of the carbon nanoparticles and aggregates into other mixtures of materials.

In some embodiments, either before or after post-processing, the carbon nanoparticles and aggregates described herein are added to solids, liquids or slurries of other elements or compounds to form additional mixtures of materials incorporating the unique properties of the carbon nanoparticles and aggregates. In some embodiments, the carbon nanoparticles and aggregates described herein are mixed with other solid particles, polymers or other materials.

In some embodiments, either before or after post-processing, the carbon nanoparticles and aggregates described herein are used in various applications beyond the present disclosure. Such applications including but not limited to transportation applications (e.g., automobile and truck tires, couplings, mounts, elastomeric o-rings, hoses, sealants, grommets, etc.) and industrial applications (e.g., rubber additives, functionalized additives for polymeric materials, additives for epoxies, etc.).

FIGS. 12A and 12B show transmission electron microscope (TEM) images of as-synthesized carbon nanoparticles. The carbon nanoparticles of FIG. 12A (at a first magnification) and FIG. 12B (at a second magnification) contain connected multi-walled spherical fullerenes 1202 (MWSFs) with graphene layers 1204 that coat the connected MWSFs. The ratio of MWSF to graphene allotropes in this example is approximately 80% due to the relatively short resonance times. The MWSFs in FIG. 12A are approximately 5 nm to 10 nm in diameter, and the diameter can be from 5 nm to 500 nm using the conditions described above. In some embodiments, the average diameter across the MWSFs is in a range from 5 nm to 500 nm, or from 5 nm to 250 nm, or from 5 nm to 100 nm, or from 5 nm to 50 nm, or from 10 nm to 500 nm, or from 10 nm to 250 nm, or from 10 nm to 100 nm, or from 10 nm to 50 nm, or from 40 nm to 500 nm, or from 40 nm to 250 nm, or from 40 nm to 100 nm, or from 50 nm to 500 nm, or from 50 nm to 250 nm, or from 50 nm to 100 nm. Of course, average MWSF diameter within the scope of the presently disclosed inventive embodiments may have any of the foregoing values or be within any of the foregoing exemplary ranges, or between any of the foregoing exemplary ranges, without limitation and without departing from the scope of the presently described inventive concepts. No catalyst was used in this process, and therefore, there is no central seed containing contaminants. The aggregate particles produced in this example had a particle size of approximately 10 μm to 100 μm, or approximately 10 μm to 500 μm.

FIG. 12C shows the Raman spectrum of the as-synthesized aggregates in this example taken with 532 nm incident light. The I_{D}/I_{G} for the aggregates produced in this example is from approximately 0.99 to 1.03, indicating that the aggregates were composed of carbon allotropes with a high degree of order.

FIG. 12D and FIG. 12E show example TEM images of the carbon nanoparticles after size reduction by grinding in a ball mill. The ball milling was performed in cycles with a 3 minute counter-clockwise grinding step, followed by a 6 minute idle step, followed by a 3 minute clockwise grinding step, followed by a 6 minute idle step. The grinding steps were performed using a rotation speed of 400 rpm. The milling media was zirconia and ranged in size from 0.1 mm to 10 mm. The total size reduction processing time was from 60 minutes to 120 minutes. After size reduction, the aggregate particles produced in this example had a particle size of approximately 1 μm to 5 μm. The carbon nanoparticles after size reduction are connected MWSFs with layers of graphene coating the connected MWSFs.

FIG. 12F shows a Raman spectrum from these aggregates after size reduction taken with a 532 nm incident light. The I_{D}/I_{G} for the aggregate particles in this example after size reduction is approximately 1.04. Additionally, the particles after size reduction had a Brunauer, Emmett and Teller (BET) specific surface area of approximately 40 m²/g to 50 m²/g.

The purity of the aggregates produced in this sample were measured using mass spectrometry and x-ray fluorescence (XRF) spectroscopy. The ratio of carbon to other elements, except for hydrogen, measured in 16 different batches was from 99.86% to 99.98%, with an average of 99.94% carbon.

In this example, carbon nanoparticles were generated using a thermal hot-wire processing system. The precursor material was methane, which was flowed from 1 slm to 5 slm. With these flow rates and the tool geometry, the resonance time of the gas in the reaction chamber was from approximately 20 second to 30 seconds, and the carbon particle production rate was from approximately 20 g/hr.

Further details pertaining to such a processing system can be found in the previously mentioned U.S. Pat. No. 9,862,602, titled “CRACKING OF A PROCESS GAS.”

FIG. 12G, FIG. 12H and FIG. 12I show TEM images of as-synthesized carbon nanoparticles of this example. The carbon nanoparticles contain connected multi-walled spherical fullerenes (MWSFs) with layers of graphene coating the connected MWSFs. The ratio of multi-walled fullerenes to graphene allotropes in this example is approximately 30% due to the relatively long resonance times allowing thicker, or more, layers of graphene to coat the MWSFs. No catalyst was used in this process, and therefore, there is no central seed containing contaminants. The as-synthesized aggregate particles produced in this example had particle sizes of approximately 10 μm to 500 μm. FIG. 12J shows a Raman spectrum from the aggregates of this example. The Raman signature of the as-synthesized particles in this example is indicative of the thicker graphene layers which coat the MWSFs in the as-synthesized material. Additionally, the as-synthesized particles had a Brunauer, Emmett and Teller (BET) specific surface area of approximately 90 m²/g to 100 m²/g.

FIG. 12K and FIG. 12L show TEM images of the carbon nanoparticles of this example. Specifically, the images depict the carbon nanoparticles after performance of size reduction by grinding in a ball mill. The size reduction process conditions were the same as those described as pertains to the foregoing FIG. 12G through FIG. 12J. After size reduction, the aggregate particles produced in this example had a particle size of approximately 1 μm to 5 μm. The TEM images show that the connected MWSFs that were buried in the graphene coating can be observed after size reduction. FIG. 12M shows a Raman spectrum from the aggregates of this example after size reduction taken with 532 nm incident light. The I_{D}/I_{G} for the aggregate particles in this example after size reduction is approximately 1, indicating that the connected MWSFs that were buried in the graphene coating as-synthesized had become detectable in Raman after size reduction, and were well ordered. The particles after size reduction had a Brunauer, Emmett and Teller (BET) specific surface area of approximately 90 m²/g to 100 m²/g.

FIG. 12N is a scanning electron microscope (SEM) image of carbon aggregates showing the graphite and graphene allotropes at a first magnification. FIG. 12O is a SEM image of carbon aggregates showing the graphite and graphene allotropes at a second magnification. The layered graphene is clearly shown within the distortion (wrinkles) of the carbon. The 3D structure of the carbon allotropes is also visible.

The particle size distribution of the carbon particles of FIG. 12N and FIG. 12O is shown in FIG. 12P. The mass basis cumulative particle size distribution 1206 corresponds to the left y-axis in the graph (Q³(x)[%]). The histogram of the mass particle size distribution 1208 corresponds to the right axis in the graph (dQ³(x)[%]). The median particle size is approximately 33 μm. The 10th percentile particle size is approximately 9 μm, and the 90th percentile particle size is approximately 103 μm. The mass density of the particles is approximately 10 g/L.

The particle size distribution of the carbon particles captured from a multiple-stage reactor is shown in FIG. 12Q. The mass basis cumulative particle size distribution 1214 corresponds to the left y-axis in the graph (Q³(x)[%]). The histogram of the mass particle size distribution 1212 corresponds to the right axis in the graph (dQ³(x)[%]). The median particle size captured is approximately 11 μm. The 10th percentile particle size is approximately 3.5 μm, and the 90th percentile particle size is approximately 21 μm. The graph in FIG. 12Q also shows the number basis cumulative particle size distribution 1218 corresponding to the left y-axis in the graph (Q⁰(x)[%]). The median particle size by number basis is from approximately 0.1 μm to approximately 0.2 μm. The mass density of the particles collected is approximately 22 g/L.

Returning to the discussion of FIG. 12P, the graph also shows a second set of example results. Specifically, in this example, the particles were size-reduced by mechanical grinding, and then the size-reduced particles were processed using a cyclone separator. The mass basis cumulative particle size distribution 1210 of the size-reduced carbon particles captured in this example corresponds to the left y-axis in the graph (Q³ (x) [%]). The histogram of the mass basis particle size distribution 1212 corresponds to the right axis in the graph (dQ³(x)[%]). The median particle size of the size-reduced carbon particles captured in this example is approximately 6 μm. The 10th percentile particle size is from 1 μm to 2 μm, and the 90th percentile particle size is from 10 μm to 20 μm.

Further details pertaining to making and using cyclone separators can be found in U.S. patent application Ser. No. 15/725,928, filed Oct. 5, 2017, titled “MICROWAVE REACTOR SYSTEM WITH GAS-SOLIDS SEPARATION”, which is hereby incorporated by reference in its entirety.

### High Purity Carbon Allotropes Produced Using Microwave Reactor Systems

In some cases, carbon particles and aggregates containing graphite, graphene and amorphous carbon can be generated using a microwave plasma reactor system using a precursor material that contains methane, or contains isopropyl alcohol (IPA), or contains ethanol, or contains a condensed hydrocarbon (e.g., hexane). In some other examples, the carbon-containing precursors are optionally mixed with a supply gas (e.g., argon). The particles produced in this example contained graphite, graphene, amorphous carbon and no seed particles. The particles in this example had a ratio of carbon to other elements (other than hydrogen) of approximately 99.5% or greater.

In one particular example, a hydrocarbon was the input material for the microwave plasma reactor, and the separated outputs of the reactor comprised hydrogen gas and carbon particles containing graphite, graphene and amorphous carbon. The carbon particles were separated from the hydrogen gas in a multi-stage gas-solid separation system. The solids loading of the separated outputs from the reactor was from 0.001 g/L to 2.5 g/L.

FIG. 12R, FIG. 12S, and FIG. 12T are TEM images of as-synthesized carbon nanoparticles. The images show examples of graphite, graphene and amorphous carbon allotropes. The layers of graphene and other carbon materials can be clearly seen in the images.

The particle size distribution of the carbon particles captured is shown in FIG. 12U. The mass basis cumulative particle size distribution 1220 corresponds to the left y-axis in the graph (Q³(x)[%]). The histogram of the mass particle size distribution 1222 corresponds to the right axis in the graph (dQ³(x)[%]). The median particle size captured in the cyclone separator in this example was approximately 14 μm. The 10th percentile particle size was approximately 5 μm, and the 90th percentile particle size was approximately 28 μm. The graph in FIG. 12U also shows the number basis cumulative particle size distribution 1224 corresponding to the left y-axis in the graph (Q⁰(x)[%]). The median particle size by number basis in this example was from approximately 0.1 μm to approximately 0.2 μm.

FIG. 12V, FIG. 12W, and FIG. 12X, and 12Y are images that show three-dimensional carbon-containing structures that are grown onto other three-dimensional structures. FIG. 12V is a 100× magnification of three-dimensional carbon structures grown onto carbon fibers, whereas FIG. 12W is a 200× magnification of three-dimensional carbon structures grown onto carbon fibers. FIG. 12X is a 1201× magnification of three-dimensional carbon structures grown onto carbon fibers. The three-dimensional carbon growth over the fiber surface is shown. FIG. 12Y is a 10000× magnification of three-dimensional carbon structures grown onto carbon fibers. The image depicts growth onto the basal plane as well as onto edge planes.

More specifically, FIGS. 12V-12Y show example SEM images of 3D carbon materials grown onto fibers using plasma energy from a microwave plasma reactor as well as thermal energy from a thermal reactor. FIG. 12V shows an SEM image of intersecting fibers 1231 and 1232 with 3D carbon material 1230 grown on the surface of the fibers. FIG. 12W is a higher magnification image (the scale bar is 300 μm compared to 500 μm for FIG. 12V) showing 3D carbon growth 1230 on the fiber 1232. FIG. 12X is a further magnified view (scale bar is 40 μm) showing 3D carbon growth 1230 on fiber surface 1235, where the 3D nature of the carbon growth 1230 can be clearly seen. FIG. 12Y shows a close-up view (scale bar is 500 nm) of the carbon alone, showing interconnection between basal planes 1236 and edge planes 1234 of numerous sub-particles of the 3D carbon material grown on the fiber. FIGS. 12V-12Y demonstrate the ability to grow 3D carbon on a 3D fiber structure according to some embodiments, such as 3D carbon growth grown on a 3D carbon fiber.

In some embodiments, 3D carbon growth on fibers can be achieved by introducing a plurality of fibers into the microwave plasma reactor and using plasma in the microwave reactor to etch the fibers. The etching creates nucleation sites such that when carbon particles and sub-particles are created by hydrocarbon disassociation in the reactor, growth of 3D carbon structures is initiated at these nucleation sites. The direct growth of the 3D carbon structures on the fibers, which themselves are three-dimensional in nature, provides a highly integrated, 3D structure with pores into which resin can permeate. This 3D reinforcement matrix (including the 3D carbon structures integrated with high aspect ratio reinforcing fibers) for a resin composite results in enhanced material properties, such as tensile strength and shear, compared to composites with conventional fibers that have smooth surfaces and which smooth surfaces typically delaminate from the resin matrix.

### Functionalizing Carbon

In some embodiments, carbon materials, such as 3D carbon materials described herein, can be functionalized to promote adhesion and/or add elements such as oxygen, nitrogen, carbon, silicon, or hardening agents. In some embodiments, the carbon materials can be functionalized in situ—that is, within the same reactor in which the carbon materials are produced. In some embodiments, the carbon materials can be functionalized in post-processing. For example, the surfaces of fullerenes or graphene can be functionalized with oxygen- or nitrogen-containing species which form bonds with polymers of the resin matrix, thus improving adhesion and providing strong binding to enhance the strength of composites.

Embodiments include functionalizing surface treatments for carbon (e.g., CNTs, CNO, graphene, 3D carbon materials such as 3D graphene) utilizing plasma reactors (e.g., microwave plasma reactors) described herein. Various embodiments can include in situ surface treatment during creation of carbon materials that can be combined with a binder or polymer in a composite material. Various embodiments can include surface treatment after creation of the carbon materials while the carbon materials are still within the reactor.

A number of implementations have been described. Nevertheless, it will be understood that various modifications may be made without departing from the spirit and scope of the disclosure. Accordingly, other implementations are within the scope of the following claims.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein included the one or more modes known to the inventor for carrying out the claimed subject matter. Of course, variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. An electrode of an electrochemical cell, comprising:
a cathode,
an active material; and
a binder slurry comprising a polymer and microfiber, wherein the polymer is at least 0.25% weight of a combination of the active material and the binder slurry, and the microfiber is at least 1% weight of the combination.

2. The electrode of claim 1, wherein the binder slurry is aqueous.

3. The electrode of claim 1, wherein the microfiber is water-dispersible.

4. The electrode of claim 1, wherein the microfiber is nanofibrillated cellulose.

5. The electrode of claim 1, wherein the microfiber is microfibrillated cellulose (MFC).

6. The electrode of claim 5, wherein the MFC is configured to have a diameter between 10-100 nm.

7. The electrode of claim 5, wherein the MFC is configured to have a length of at least 10 microns.

8. The electrode of claim 1, wherein the polymer includes partially lithiated polyacrylic acid (LiPAA).

9. The electrode of claim 1, wherein the active material is configured to have a surface area of at least 100 m²/g.

10. The electrode of claim 1, wherein the active material is a lithium-sulfur compound.

11. The electrode of claim 1, wherein the binder slurry is configured to form a 3D structure.

12. The electrode of claim 11, wherein the 3D structure is formed based on entangling of the microfiber.

13. The electrode of claim 12, wherein at least one of:
the microfiber is bonded to the active material, or
the microfiber is bonded between a first fiber of the microfiber and a second fiber of the microfiber.

14. The electrode of claim 1, wherein the electrode is configured such that an adhesion of the electrode is greater compared to an electrode configured without the microfiber.

15. The electrode of claim 1, wherein the electrode is configured such that cycling of the electrode is increased compared to an electrode configured without the microfiber.

16. The electrode of claim 1, wherein the electrode is configured such that a cohesion of the electrode is greater compared to an electrode configured without the microfiber.

17. The electrode of claim 16, wherein the electrode is configured such that the active material is secured by the microfiber, and the securing increases the cohesion of the electrode.

18. The electrode of claim 17, wherein the electrode is configured such that the microfiber increases a structural integrity of the electrode.

19. The electrode of claim 1, wherein the electrode is configured such that a coating texture of the electrode is based on the polymer.

20. The electrode of claim 1, wherein the active material includes one or more carbonaceous materials.
